(19) United States
(12) Patent Application Publication
(10) Pub. No.: US 2026/0150070 A1
(43) Pub. Date: May 28, 2026

(54) COMMUNICATION DEVICE, TERMINAL DEVICE, AND COMMUNICATION SYSTEM

(71) Applicant: SONY GROUP CORPORATION, TOKYO (JP)

(72) Inventor: SHINICHIRO TSUDA, TOKYO (JP)

(21) Appl. No.: 19/114,538

(22) PCT Filed: Sep. 19, 2023
(86) PCT No.: PCT/JP2023/033911

§ 371 Date: Mar. 24, 2025

(30) Foreign Application Priority Data
Sep. 30, 2022 (JP) 2022-157876

(51) Int. Cl. H04W 60/00; H04W 48/18

(52) U.S. Cl. CPC H04W 60/002; H04W 48/18

(57) ABSTRACT

[Object] The present disclosure provides a communication device, a terminal device, and communication system to improve availability of network slices. [Solving Means] A communication device according to the present disclosure includes at least one processor and a transceiver. The at least one processor receives, from a terminal device, a first set of identification information regarding at least one first network slice whose registration in a registration area of a home public land mobile network is requested; acquires first information regarding whether to allow registration of the first network slice in the registration area, the first network slice being indicated by the identification information in the first set; and creates, on the basis of the first information, second information regarding a visitor public land mobile network that enables the first network slice to be provided in an area overlapping with at least the registration area.

### TECHNICAL FIELD

The present disclosure relates to a communication device, a terminal device, and a communication system.

### BACKGROUND ART

For a fifth generation mobile communication system, so-called 5G, which has characteristics of high speed and large capacity (eMBB: enhanced Mobile BroadBand), low latency and high reliability (URLLC: Ultra-Reliable and Low Latency Communications), and multiple simultaneous connections (mMTC: Massive Machine Type Communication), the first standard was established as Rel-15 in 2018, and services compatible with 5G were launched in Japan in March 2020. In addition, 5G is compatible with a concept referred to as network slicing that enables to efficiently process various traffic with different requests to communications depending on its purposes.

### CITATION LIST

### Patent Literature

Patent Literature 1: JP 2021-166359A

### DISCLOSURE OF INVENTION

### Technical Problem

Availability of network slices of 5G systems are designed in units of areas referred to as Tracking Areas (TA), and registration for use of the network slices is performed in units of Registration Area (RA) including one or more tracking areas. Different network slices have different availabilities, and methods for efficiently managing network slices having different availabilities in units of registration areas have been desired. In addition, a network slice that requests high throughput is assumed to be provided through a cell that supports higher carrier frequency such as millimeter waves. Therefore, management methods with finer granularity than the tracking areas have also been desired due to restrictions on the number of base stations to be installed in view of their narrow coverage and economic rationality. In addition, utilization of roaming has also been considered to improve the availability of network slices, and efficient roaming methods in units of network slices have been desired.

Patent Literature 1 discloses a method of storing information regarding Allowed NSSAI (Network Slice Selection Assistance Information) separately as allowed NSSAI for each PLMN (Public Land Mobile Network) in a case where information regarding a plurality of tracking areas included in information indicating a registration area contains tracking areas belonging to different PLMNs, the Allowed NSSAI being a set of network slices whose registration is allowed. However, Patent Literature 1 never mentions provision of information necessary for complement by usage of network slices utilizing roaming in a tracking area of a network slice whose registration is rejected, its procedure, or a method of handling a tracking area that is set independently for each PLMN. Also, Patent Literature 1 never mentions a method of improving availability of network slices by utilizing the roaming in a tracking area of a network slice whose usage is restricted under admission control.

The present disclosure provides a communication device, a terminal device, and communication system to improve availability of network slices.

### Solution to Problem

A communication device according to the present disclosure includes at least one processor and a transceiver. The at least one processor receives, from a terminal device, a first set of identification information regarding at least one first network slice whose registration in a registration area of a home public land mobile network is requested; acquires first information regarding whether to allow registration of the first network slice in the registration area, the first network slice being indicated by the identification information in the first set; and creates, on the basis of the first information, second information regarding a visitor public land mobile network that enables the first network slice to be provided in an area overlapping with at least the registration area.

### BRIEF DESCRIPTION OF DRAWINGS

FIG. 1 is a diagram illustrating a configuration of network architecture of a 5G system.

FIG. 2 is a diagram illustrating a configuration of network architecture of a 5G system for roaming.

FIG. 3 is a table illustrating standardized SST values.

FIG. 4 is a diagram illustrating an example of a QoS architecture of a 5GS.

FIG. 5 is a diagram illustrating an example of deployment of network slices of the 5GS.

FIG. 6 is a diagram illustrating another example of deployment of network slices of the 5GS.

FIG. 7 is a diagram illustrating an example of a network slice registration determination process in a registration process.

FIG. 8 is a diagram illustrating an example of a process of creating supplemental information regarding Rejected S-NSSAI in the registration process.

FIG. 9A is a diagram illustrating an example of a registration process to the 5GS.

FIG. 9B is a diagram illustrating the example of the registration process to the 5GS.

FIG. 10 is a diagram illustrating an example a procedure of checking availability of a network slice.

FIG. 11A is a diagram illustrating an example of a process performed by an HPLMN side with regard to candidate SNPN detection.

FIG. 11B is a diagram illustrating an example of a process performed by a SNPN side with regard to the candidate SNPN detection.

FIG. 12 is a diagram illustrating an example of a process of updating registration information associated with admission control.

FIG. 13 is a diagram illustrating an example of a process of updating registration information associated with network maintenance management.

FIG. 14 is a block diagram illustrating an example configuration of a terminal device according to the present disclosure.

FIG. 15 is a block diagram illustrating an example configuration of a communication device according to the present disclosure.

### MODE(S) FOR CARRYING OUT THE INVENTION

Hereinafter, embodiments of the present invention will be described with reference to the drawings. An embodiment of the present invention relates to a communication device, a terminal device, and communication system that execute processes to improve availability of network slices, for example.

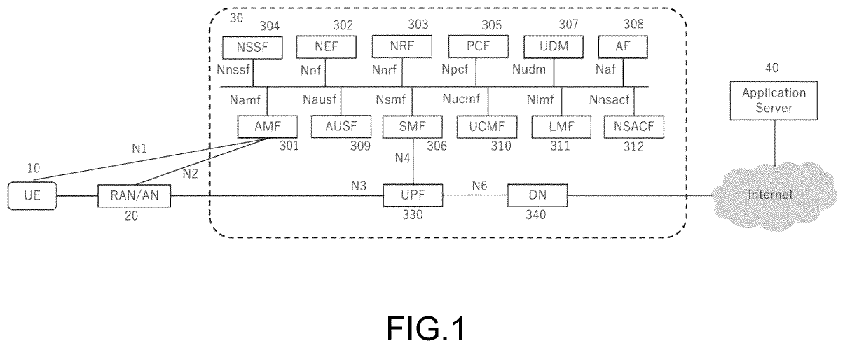

FIG. 1 is a diagram illustrating a configuration of network architecture of a 5G system. Hereinafter, the 5G system is abbreviated to 5GS.

As illustrated in FIG. 1, the 5GS includes User Equipment (UE) 10, an (R)AN 20, and a 5G Core (5GC) 30. Note that, the 5GC 30 is also referred to as an NG CORE (NGC) or a core network. In addition, the (R)AN represents a base station device including a Radio Access Network (RAN) and an Access Network (AN). In addition, the UE 10 is the terminal device described above. When the 5GS gets connected to an Application Server (AS) 40 that processes applications via the Internet, the UE 10 can utilize applications through the 5G service.

The application server 40 is disposed as a DN 340 in the 5GC 30 in a case where a subject that provides applications such as a service provider has an agreement such as Service Level Agreement (SLA) with a Public Land Mobile Network (PLMN) operator that provides the 5G service. Alternatively, the application server 40 and the DN 340 may be connected to each other via a dedicated line or a Virtual Private Network (VPN). Note that, the application server 40 is also referred to as a cloud server, and may be provided in a form of edge server.

A function group of a control plane of the 5GS includes an Access and Mobility Management Function (AMF) 301, a Network Exposure Function (NEF) 302, and a Network Repository Function (NRF) 303. The function group of the control plane also includes a Network Slice Selection Function (NSSF) 304, a Policy Control Function (PCF) 305, a Session Management Function (SMF) 306, and a Unified Data Management (UDM) 307. The function group of the control plane includes an Application Function (AF) 308, an Authentication Server Function (AUSF) 309, and a UE radio Capability Management Function (UCMF) 310. The function group of the control plane includes a Location Management Function (LMF) 311 and a Network Slice Access Control Function (NSACF) 312. As described above, the function group of the control plane includes the plurality of Network Functions (NFs).

At least one or any combination of functions of the function group of the control plane corresponds to the above-described communication device. For example, the AMF 301 corresponds to the above-described communication device.

Here, the AF 308 may operate as an NF that process a control plane of the application server 40. The AF 308 may be implemented as an entity that is logically different from the application server 40 but is in a physically same device. In other words, the AF 308 may be implemented in the application server 40. In addition, the AF 308 may operate as an NF that process a control plane with regard to applications of the 5GS, and may be disposed in the 5GC 30.

A service provider that manages and operates the application server 40 makes it possible to acquire information from respective NFs in the 5G system via the NEF 302 within the scope of the SLA with the PLMN operator. The NEF 302 makes it possible to securely ensure and expose events and capabilities of the respective NFs to the service provider.

The UDM 307 includes a Unified Data Repository (UDR) and a Front End (FE) . The UDR holds and manages subscriber information. The FE processes the subscriber information.

The AMF 301 performs mobility management. Details of behavior of the AMF 301 according to the present embodiment will be described later.

The SMF 306 performs session management.

The PCF 305 provides unified policy architecture to govern behavior of the network, and provides policy rules to respective network functions of the control plane. The PCF 305 also accesses the subscriber information in the UDR to decide the policy.

The UCMF 310 holds UE Radio Capability Information corresponding to all UE Radio Capability IDs in a PLMN. The UCMF 310 takes a role of assigning respective PLMN-assigned UE Radio Capability IDs.

Note that, the NSSF 304, the LMF 311, and the NSACF 312 will be described later.

A Namf is a service-based interface provided by the AMF 301. A Nsmf is a service-based interface provided by the SMF 306. A Nnef is a service-based interface provided by the NEF 302.

A Npcf is a service-based interface provided by the PCF 305. A Nudm is a service-based interface provided by the UDM 307. A Naf is a service-based interface provided by the AF 308. A Nnrf is a service-based interface provided by the NRF 303.

A Nnssf is a service-based interface provided by the NSSF 304. A Nausf is a service-based interface provided by the AUSF 309. A Nucmf is a service-based interface provided by the UCMF 310. A Nlmf is a service-based interface provided by the LMF 311. A Nnsacf is a service-based interface provided by the NSACF 312.

Each of the NFs makes it possible to receive a response or notification from a service provided by another network function, by requesting or subscribing the service. In other words, each of the NFs exchange information with other NFs through the request/response or the subscription/notification via its service-based interface.

A User Plane Function (UPF) 330 has a function of user plane process. The Data Network (DN) 340 has a function that makes it possible to connect to a service unique to a Mobile Network Operator (MNO), the Internet, and a service by a third party. The UPF 330 functions as a data forwarding processor of a user plane processed by the application server 40. The UPF 330 also functions as a gateway connected to the (R)AN 20.

Here, the 5GS makes it possible to configure the respective NFs of the 5GC 30 through Containerization, Virtualization, or the like to implement them in a cloud server. In addition, the 5GS makes it possible to set the respective NFs dynamically and reconfigurably through Software-Defined Networking (SDN).

The (R)AN 20 has a function that makes it possible to connect to the RAN or the AN other than the RAN. The (R)AN 20 includes a base station referred to as qNB or ng-eNB. Sometimes the RAN may be referred to as Next-Generation RAN (NG-RAN).

In addition, functions of the (R)AN 20 are divided into a Central Unit (CU) and a Distributed Unit (DU). The CU processes L2/L3 functions of a Packet Data Convergence Protocol (PDCP) sublayer and above. The DU processes L2/L1 functions of a Radio Link Control (RLC) sublayer and below. The functions of the (R)AN 20 may be dispersedly distributed via respective F1 interfaces.

In addition, functions of the DU are divided into a Radio Unit (RU) and a DU. The RU processes a low PHY sublayer and a wireless unit (radio). The DU processes the RLC sublayer, a Medium Access Control (MAC) sublayer, and a high PHY sublayer. Functions of the RU are dispersedly distributed via fronthauls compliant with the evolved Common Public Radio Interface (eCPRI).

Here, the 5GS makes it possible to configure the functions of the CU and/or DU through containerization, virtualization, or the like to implement them in the cloud server. In addition, the 5GS makes it possible to set the functions of the CU and/or DU dynamically and reconfigurably through the SDN.

The UE10 and the AMF 301 mutually exchange information via a reference point N1. The (R)AN20 and the AMF 301 mutually exchange information via a reference point N2. The SMF306 and the UPF 330 mutually exchange information via a reference point N4.

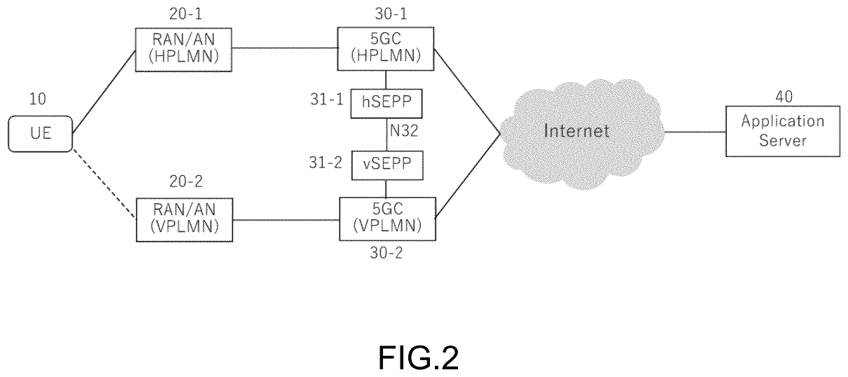

FIG. 2 is a diagram illustrating a configuration of network architecture of a 5G system for roaming.

A visitor PLMN (VPLMN) having SLA with a home PLMN (HPLMN) makes it possible to provide 5G services to the UE 10 through roaming. A 5GS of the HPLMN includes a (R)AN 20-1 and a 5GC 30-1. A 5GS of the VPLMN includes a (R)AN 20-2 and a 5GC 30-2.

The UE 10 makes it possible to access a service provided by the application server 40 through a 5G service of the HPLMN by the (R)AN 20-1 and the 5GC 30-1.

In addition, by using the roaming, the UE 10 makes it possible to access the service provided by the application server 40 through a 5G service of the HVPLMN by the (R)AN 20-2 and the 5GC 30-2.

A control plane of the 5GC 30-1 of the HPLMN and a control plane of the 5GC 30-2 of the VPLMN are connected via security edge protection proxies (SEPPs). A home SEPP (hSEPP) of the control plane of the 5GC 30-1 and a visitor SEPP (vSEPP) of the control plane of the 5GC 30-2 are connected via a reference point N32.

Respective NFs of the control plane of the 5GC 30-1 will be indicated by adding “−1” to the end of reference signs of corresponding NFs in FIG. 1. Respective NFs of the control plane of the 5GC 30-2 will be indicated by adding “−2” to the end of reference signs of corresponding NFs in FIG. 1.

The NFs of the control plane of the 5GC 30-1 makes it possible to request services provided by the NFs of the control plane of the 5GC 30-2 via an NEF 302-2 of the 5GC 30-2 under the SLA with the VPLMN.

The NFs of the control plane of the 5GC 30-2 makes it possible to request services provided by the NFs of the control plane of the 5GC 30-1 via an NEF 301-2 of the 5GC 30-1 under the SLA with the HPLMN.

At the time of roaming, a user plane of the 5GC 30-2 is connected to the application server 40 through local breakout roaming or home-routed roaming. In the local breakout roaming, A UPF 330-2 of the 5GC 30-2 is directly connected to the application server 40. In the home-routed roaming, the UPF 330-2 of the 5GC 30-2 is connected to a UPF 330-1 of the 5GC 30-1 via a reference point N9, and is connected to the application server 40 via the UPF 330-1 of the 5GC 30-1.

### 1. Network Slice Selection Assistance Information (NSSAI)

The network slice is a unit of service divided depending on features (for example, data rate, delay, or the like) of communication required for respective communication services provided through the 5G.

To each network slice, Single Network Slice Selection Assist Information (S-NSSAI) is assigned as information to assist selection of network slices (network slice selection assistance information). The S-NSSAI includes a pair of a Slice/Service Type (SST) and a Slice Differentiator (SD). The SST is mandatory, consists of 8 bits, and identifies slice types. The SD is optional, consists of 24 bits, and distinguishes different slices in a same SST.

The S-NSSAI can use a standardized SST or its own SST that is not standardized. In a case of using a standardized S-NSSAI value, the S-NSSAI only includes the standardized SST without the SD. On the other hand, in a case of using a non-standardized S-NSSAI value, the S-NSSAI includes a pair of standardized SST and SD, includes a pair of non-standardized SST and SD, or includes the non-standardized SST only. The non-standardized S-NSSAI value can be used only in a PLMN that uses the value uniquely, that is, only in a telecom operator.

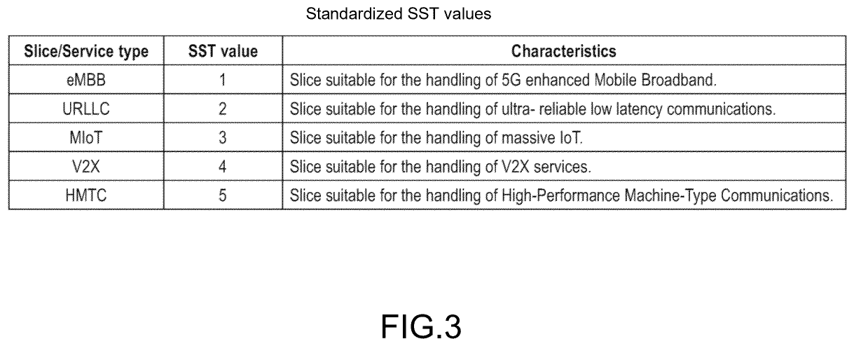

FIG. 3 is a table illustrating standardized SST values. This table is based on a table illustrated in “3GPP TS23.501”. The above-described “case of using a standardized S-NSSAI” corresponds to a case of using S-NSSAI values consisting only of such SST values (eMBB: 1, URLLC: 2, MIOT: 3, V2X: 4, and HMTC: 5). In other words, non-standardized S-NSSAI values are used for network slices other than that (for example, network slices subdivided by the SD).

Network slice configuration information includes one or more Configured NSSAI(s). A Serving Public Land Mobile Network (Serving PLMN) makes it possible to set configured NSSAI applied to each PLMN for the UE 10. Alternatively, the Home PLMN (HPLMN) makes it possible to set Default Configured NSSAI for the UE 10. Only in a case where the Configured NSSAI for the Serving PLMN is not set for the UE 10, the UE 10 under the Serving PLMN makes it possible to use the Default Configured NSSAI.

Note that, the Default Configured NSSAI may be set in advance for the UE 10. In addition, the UDM 307 of the HPLMN may provide or update the Default Configured NSSAI by using UE Parameters Update through a UDM Control Plane process.

The Configured NSSAI includes one or more S-NSSAI(s).

Requested NSSAI is NSSAI provided from the UE 10 to the serving PLMN in a registration process. The Requested NSSAI is required to be one of the following:
Default Configured NSSAI;
Configured NSSAI;
Allowed NSSAI or part thereof; or
NSSAI obtained by adding one or more S-NSSAIs included in Configured NSSAI to the Allowed-NSSAI or part thereof

The Allowed NSSAI is, for example, NSSAI provided from the Serving PLMN to the UE 10 during the registration process. The Allowed NSSAI indicates values of one or more S-NSSAI(s) that are available within a current Registration Area of the current Serving PLMN.

Rejected S-NSSAI indicates a value of S-NSSAI that are unavailable within at least one Tracking Area in the current Registration Area of the current Serving PLMN among one or more S-NSSAI(s) included in the Rejected S-NSSAI.

Here, the Tracking Area is an area to be used for mobility management, and identified by Tracking Area Identity (TAI). To transmit a message or data to the UE 10 in an RRC IDLE state, the network (PLMN) manages the location of the UE 10 within the range of a Tracking Area set on which the UE 10 camps. When registering the UE 10 on the network, the AMF 301 assigns a Tracking Area set included in a TAI list, as an area (Registration Area) on which the UE 10 is to be registered. In other words, the network manages the registered UE 10 in such a manner that the registered UE 10 camps on any Tracking Area in the TAI list.

When detecting an optimal cell according to criteria for cell reselection, the UE 10 reselects and camps on the cell. At this time, a location registration process, that is, a process of updating the TAI list is executed in a case where the selected cell does not belong to any Tracking Area in the TAI list registered by the UE 10.

The Subscribed S-NSSAI is an S-NSSAI that is available for the UE 10 in the PLMN according to agreement information.

The NSSF 304 decides the Allowed NSSAI and the Configured NSSAI, and decides an AMF set that is a list of candidates for the AMF 301. For example, an AMF 301 may be selected from the list of candidates in accordance with a network slice used by the UE 10 and other criteria, and the UE 10 is assigned to the selected AMF 301.

The one or more S-NSSAI(s) included in the Allowed NSSAI to be provided to the UE 10 may include a value that is not a part of the current network slice configuration information regarding the UE 10 with regard to the Serving PLMN. In this case, the network provides mapping of respective S-NSSAI(s) of the Allowed NSSAI and corresponding S-NSSAI(s) of the HPLMN, in accordance with the Allowed NSSAI. Such information regarding the mapping allows the UE 10 to associate an application with the S-NSSAI of the HPLMN and the corresponding S-NSSAI of the Allowed NSSAI in accordance with each Network Slice Selection Policy (NSSP) under UE Route Selection Policy (URSP) rules, or in accordance with each local configuration of the UE 10.

For example, if the HPLMN and/or the VPLMN (Visitor PLMN) uses a non-standardized S-NSSAI value, it is necessary for the UE 10 to provide information regarding mapping of S-NSSAI values included in the Requested NSSAI and corresponding S-NSSAI values used in the HPLMN, at the time of roaming. Here, it is possible for the UE 10 to acquire the information regarding mapping in advance from the Serving PLMN, as mapping of S-NSSAI values included in the Configured NSSAI with regard to the Serving PLMN and corresponding S-NSSAI values used in the HPLMN, or as mapping of S-NSSAI values included in the Allowed NSSAI with regard to an access type and the Serving PLMN and corresponding S-NSSAI values used in the HPLMN.

### 2. QoS Control in 5G System

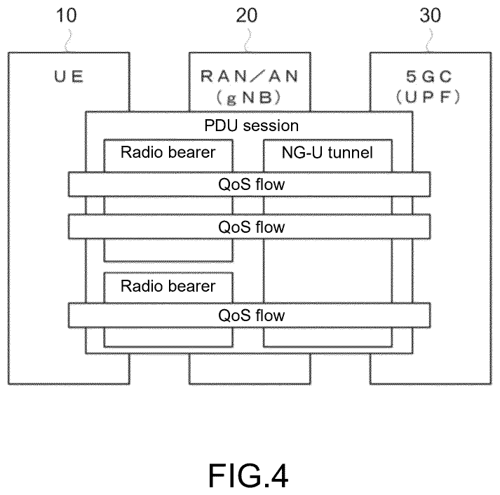

FIG. 4 is a diagram illustrating an example of a QoS architecture of a 5GS. FIG. 4 is based on a drawing illustrated in “3GPP TS38.300”.

At Non-Access Stratum (NAS) level, a QoS flow is the finest granularity of QoS differentiation in a Protocol Data Unit (PDU) session. The QOS flow is identified within the PDU session by a QoS Flow ID (QFI).

In addition, in an XR or media service, payload of a PDU set is conveyed by a group of packets. The PDU set includes one or more PDU(s) that convey the payload in units of information created at application level. Examples of the units of information include image frame, video slice of the XR or media service, I, P and B frames of video data in a GOP (group of pictures) format, and the like.

In other words, packets in the PDU set are treated as a unit of data to be received and decoded within a certain period. By using the PDU set, it is possible to identify data at a finer granularity in the QoS flow that has the finest granularity in view of the QoS control. The 5GS makes it possible to apply QoS control at PDU set level in addition to QoS control at QoS flow level.

The SMF 306 associates a PCC rule with the QoS flow on the basis of the QoS and service requests. The SMF 306 assigns a QFI to a new QoS flow, and acquires a PCC rule and other information associated with the QoS flow from the PCF 305. From the PCC rule, the SMF 306 acquires a QoS profile, of the QoS flow, instructions related to a corresponding UPF (for example, N4 rule), and a QoS rule.

A base station (gNB) of the (R)AN 20 makes it possible to establish at least one Data Radio Bearer (DRB) in addition to a PDU session with the respective UEs 10. The DRB is a logical path to convey data. A 5G QoS model supports a Guaranteed flow Bit Rate (GBR) where the bandwidth is guaranteed and a Non-Guaranteed flow Bit Rate (Non-GBR) where the bandwidth is not guaranteed.

The (R)AN 20 and 5GC 30 ensure quality of service by mapping each packet to an appropriate QoS flow and DRB. That is, two-step mapping is performed. The two-step mapping includes mapping of an IP flow and a QoS flow in a Non-Access Stratum (NAS), and mapping of the QOS flow and a DRB in an Access Stratum (AS).

At the NAS level, a QoS flow is characterized by a QoS profile provided from the 5GC 30 to the (R)AN 20 and a QoS rule provided from the 5GC 30 to the UE 10.

The QoS profile is used by the (R)AN 20 to decide a processing method on a radio interface. The QoS rule is used to instruct the UE 10 on mapping of user plane traffic and QoS flows in an uplink. Accordingly, the UE 10 is not provided with a QoS rule of an MBS QoS flow or QoS parameters at a QoS flow level with regard to a multicast Multicast/Broadcast Service (MBS) session.

The QoS profile is provided to the (R)AN 20 from the SMF 306 via the AMF 401 and the reference point N2, or is configured in advance in the (R)AN 20.

In addition, the SMF 306 makes it possible to provide the UE 10 with one or more QoS rules and, if necessary, QoS flow-level QoS parameters related to the QoS rules, via the AMF 301 and the reference point N1.

In addition to this, or instead of this, Reflective QoS control may also be applied to the UE 10. The Reflective QoS control is QoS control that monitors the QFI of downlink packets and applies the same mapping to uplink packets.

The QoS flow will be a GBR QoS flow or a Non-GBR QoS flow depending on the QoS profile. The QoS profile of the QoS flow includes, for example, QoS parameters such as a 5G QoS Identifier (5QI) and Allocation and Retention Priority (ARP).

ARP includes information regarding Priority Level, Pre-emption Capability, and Pre-emption Vulnerability.

The priority defines relative importance of the QoS flow, and a smallest value of priority (Priority Level) means highest priority. The Pre-emption Capability is an indicator that defines whether a QoS flow is able to usurp resources already assigned to another QoS flow having lower priority.

The Pre-emption Vulnerability is an indicator that defines whether a QoS flow is able to yield its already assigned resources to another QoS flow having higher priority. The Pre-emption Capability and Pre-emption Vulnerability are set to either an “enabled” state or a “disabled” state.

In the GBR QoS flow, the QoS profile includes the following:
Uplink and downlink Guaranteed Flow Bit Rates (GFBRs);
Uplink and downlink Maximum Flow Bit Rates (MFBRs);
Uplink and downlink Maximum Packet Loss Rates;
Delay Critical Resource Type;
Notification Control;
and the like.

In the Non-GBR QoS flow, the QoS profile includes Reflective QoS Attribute (RQA), Additional QoS Flow Information, and the like.

The Notification Control of the QoS parameter indicates whether a notification from the (R)AN 20 is requested in a case where a QoS flow does not satisfy the GFBR. In a case where the notification control is in the “enabled” state and it is determined that the GFBR is not satisfied with regard to a GBR QoS flow, the (R)AN 20 transmits a notification about this case to the SMF 306.

In this case, the (R)AN 20 has to maintain the QoS flow except a special situation where the (R)AN 20 requests release of RAN resources of the GBR QoS flow. Examples of the special situation include Radio Link Failure or RAN Internal Congestion.

Next, in a case where a determination is made again and the determination indicates that the GFBR is satisfied with regard to the QoS flow, the (R)AN 20 transmits a new notification about this case to the SMF 306.

an Aggregate Maximum Bit Rate (AMBR) is related to Session-AMBR of each PDU session and UE-AMBR of each UE 10. The Session-AMBR limits the Aggregate Bit Rate expected to be provided across all Non-GBR QoS flows with regard to a particular PDU session, and is managed by the UPF 330. The UE-AMBR limits the Aggregate Bit Rate expected to be provided across all Non-GBR QoS flows with regard to a certain UE 10, and is managed by the (R)AN 20.

Furthermore, each UE 10 may set a Slice Maximum Bit Rate (S-MBR) with regard to the network slice (S-NSSAI). The S-MBR may be included in the subscriber information as a Subscribed UE-Slice-MBR.

The UE-Slice-MBR limits the Aggregate Bit Rate expected to be provided across all GBR and Non-GBR QoS flows belonging to all PDU sessions established by the UE 10 for the Same network slice (S-NSSAI).

The (R) AN 20 receives the UE-Slice-MBR corresponding to the network slice (S-NSSAI) from AMF301, and sets the Session-AMBR and MFBR for the UE 10 in such a manner that the sum of the MFBR of the GBR QOS flows and the Session-AMBR of all PDU sessions belonging to this network slice (S-NSSAI) is the UE-Slice-MBR.

The 5QI relates to QOS characteristics and provides guidelines (policies) for setting node-specific parameters for each QoS flow. Standardized or pre-configured 5G QoS characteristics are known from the 5QI and are not explicitly signaled. QoS characteristics to be signaled can be included as part of the QoS profile.

The QoS characteristics include information regarding Resource Type, Priority, Packet Delay Budget, Packet Error Rate, Averaging Window, Maximum Data Burst Volume, and the like. The Resource Type is a GBR QoS flow or a non-GBR QoS flow. The Packet Delay Budget may include Packet Delay Budget in 5GC 30.

At the AS level, the DRB defines a packets processing method on the radio interface (Uu interface). The DRB provides a same packet forwarding treatment for any packet.

The (R)AN 20 maps QoS flows to DRBs on the basis of the QFIs and the QoS profiles set for the QFIs. The (R)AN20 makes it possible to establish different DRBs for packets that require different packet forwarding processes (see FIG. 4).

The (R)AN20 also makes it possible to multiplex a plurality of QoS flows belonging to a same PDU session onto a same DRB (see FIG. 4).

In uplink, the mapping of QoS flows to DRBs is controlled by mapping rules that are signaled through two different methods.

One of the methods is referred to as Reflective Mapping. In the Reflective Mapping, for each DRB, the UE 10 monitors the QFI(s) of downlink packets and applies a same mapping to uplink packets.

The other of the methods is referred to as Explicit Configuration. In the Explicit Configuration, rules of mapping of QoS flows to DRBs is explicitly signaled by Radio Resource Control (RRC).

In downlink, the QFI is signaled by the (R)AN 20 on the Uu interface, for Reflective Quality of Service (RQoS).

However, neither the (R)AN 20 nor the NAS signals a QFI for a DRB on the Uu interface unless they use reflective mapping for the QoS flows carried in the DRB.

In the uplink, the (R)AN 20 makes it possible to configure signaling of the QFI towards the UE 10 on the Uu interface. The (R)AN 20 also makes it possible to configure a default DRB for each PDU session. In a case where an uplink packet does not fit either the Explicit Configuration or the Reflective Mapping, the UE 10 maps the packet to the default DRB of the PDU session.

With regard to the Non-GBR QoS flows, the 5GC 30 may transmit additional QoS flow information parameters associated with any QoS flow, to the (R)AN 20. This is done to instruct to increase frequency of certain traffic in comparison with other Non-GBR QOS flows in a same PDU session.

How to map a plurality of QoS flows in a PDU session to one DRB depends on the (R)AN 20. For example, the (R)AN 20 may map a GBR QoS flow and a Non-GBR QoS flow to a same DRB, or may map them to different DRBs. Also, the (R)AN 20 may map a plurality of GBR QoS flows to a same DRB, or may map them to different DRBs.

In 5G NR, a Service Data Adaptation Protocol (SDAP) sublayer is newly introduced for QoS control via QoS flows. The SDAP sublayer maps traffic of the QoS flows to appropriate DRBs. The SDAP sublayer is able to have a plurality of SDAP entities. The SDAP sublayer includes an SDAP entity for each PDU session on the Uu interface. The establishment or release of the SDAP entity is performed by the RRC.

The QoS flows is identified by the QFI in a PDU session container included in a GPRS Tunneling Protocol (GTP)-U header. The PDU session is identified by a GTP-U Tunnel Endpoint ID (TEID). The SDAP sublayer maps each QoS flow to a specific DRB.

When the PCF 305 receives a QoS monitoring request from the AF 308, the PCF 305 makes it possible to provide an authorized QoS monitoring policy to the SMF 306 by creating the QoS monitoring policy and including it into the PCC rule.

The SMF306 makes it possible to activate end-to-end UpLink (UL)/DownLink (DL) packet delay measurement between the UE 10 and the PSA-UPF 330 with regard to a QoS flow during a PDU session establishment procedure or during a PDU session modification procedure.

The SMF306 transmits a QOS monitoring request to the UPF 330 via the reference point N4 and transmits an N2 signal to request QoS monitoring between the UPF 330 and the (R)AN 20.

The QoS monitoring request includes monitoring variables decided by the SMF 306 on the basis of the QoS monitoring policy received from the PCF 305 or an authorized QoS monitoring policy that is locally configured in advance.

The (R)AN 20 measures the UL/DL packet delay in the (R)AN 20 portion and provides a measurement value to the UPF 330 via the reference point N3.

The UPF 330 calculates the UL/DL packet delay at the reference point N3 or N9. The UPF 330 transmits a QoS monitoring result to the SMF 306 on the basis of a predetermined condition. Here, the predetermined condition is, for example, a condition that the transmission is performed once only, a condition that the transmission is performed periodically, or a condition that the transmission is triggered by an event (event trigger).

The UPF 330 also makes it possible to support the transmission of QoS monitoring results to the AF 308 via the locally disposed NEF 302. Here, the QoS monitoring results are, for example, a measurement result of a bit rate (e.g., average bit rate, maximum bit rate) of each GBR QoS flow of a target PDU session, a measurement result of an Aggregate Bit Rate of all Non-GBR QoS flows of the target PDU session, a measurement result of a packet error rate of the target PDU session, a measurement result of an Aggregate Bit Rate of all Non-GBR QoS flows of a target UE 10, a measurement result of a packet error rate of the target UE 10, a measurement result of the UL/DL packet delay, or other results. The UL/DL packet delay is a delay including a UL/DL packet delay in the (R)AN 20 portion acquired from the (R)AN 20 and a UL/DL packet delay at the reference point N3 or N9.

In addition, in a case where the PDU session is a session via a Time-Sensitive Networking (TSN) bridge, Packet Delay Budget for a Time-Sensitive Communications (TSC) QoS flow is a sum of 5G-Access Network (AN) Packet Delay Budget (PDB) and Core Network (CN) PDB. To measure a bit rate (for example, average bit rate, maximum bit rate) between the UE 10 and the PSA-UPF 330 and to measure an end-to-end UL/DL packet delay, the above-described QoS monitoring mechanism may also be applicable to the TSC QoS flow.

### 3. Network Slice Deployment

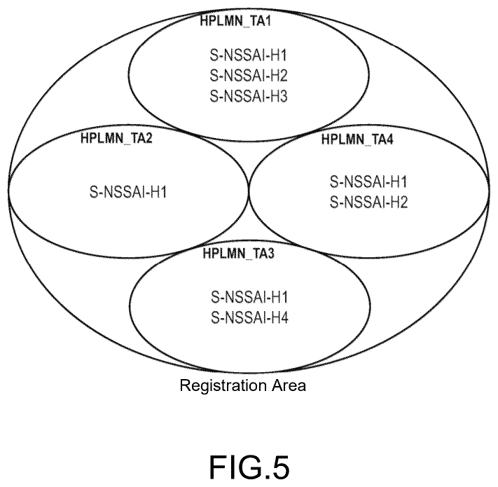

FIG. 5 is a diagram illustrating an example of network slice deployment of the 5GS. An HPLMN having a subscription with the UE 10 configures a Registration Area (RA) with regard to the UE 10. The Registration Area includes four tracking areas (TA) that are HPLMN_TA1, HPLMN_TA2, HPLMN_TA3, and HPLMN_TA4, for example.

For example, the HPLMN_TA1 supports three network slices that are S-NSSAI-H1, S-NSSAI-H2, and S-NSSAI-H3. The HPLMN_TA2 supports one network slice that is the S-NSSAI-H1. The HPLMN TA3 supports two network slices that are the S-NSSAI-H1 and S-NSSAI-H4. The HPLMN TA4 supports two network slices that are the S-NSSAI-H1 and the S-NSSAI-H2.

With regard to the UE 10, the HPLMN sets Configured NSSAI including four NSSAIs that are the S-NSSAI-H1, S-NSSAI-H2, S-NSSAI-H3, and S-NSSAI-H4.

The UE 10 makes a registration request to the HPLMN that is a serving network by using a registration request message including Requested NSSAI within this Registration Area. The Requested NSSAI may include one or more S-NSSAIs included in the Configured NSSAI. The UE 10 transmits Requested NSSAI including four NSSAIs that are, for example, the S-NSSAI-H1, S-NSSAI-H2, S-NSSAI-H3, and S-NSSAI-H4 to the HPLMN serving as the serving network.

On the basis of agreement information with the UE 10, the HPLMN confirms that the S-NSSAI-H1, S-NSSAI-H2, S-NSSAI-H3, and S-NSSAI-H4 included in the Requested NSSAI are included in the Subscribed S-NSSAI. Furthermore, on the basis of support statuses of network slices in respective Tracking Areas in the Registration Area, the HPLMN creates Allowed NSSAI including the S-NSSAI-H1, which is supported by all Tracking Areas in the Registration Area.

Furthermore, the HPLMN sets each S-NSSAI that is included in the Requested NSSAI but not included in the Allowed NSSAI, i.e., the S-NSSAI-H2, S-NSSAI-H3, and S-NSSAI-H4, as Rejected S-NSSAIs. Here, it may be possible to create Rejected NSSAI including the Rejected S-NSSAIs.

During the registration process, the UE10 acquires information regarding the Registration Area, the Allowed NSSAI, and the Rejected S-NSSAI from the HPLMN. Here, the information regarding the Registration Area is, for example, a set of Tracking Areas that constitutes the Registration Area, i.e., the HPLMN_TA1, HPLMN_TA2, HPLMN_TA3, and HPLMN_TA4. In the example of network slice deployment illustrated in FIG. 5, the UE 10 is able to use only the S-NSSAI-H1 in the Registration Area. Also, the UE 10 is not allowed to request registration of the Rejected S-NSSAI again in the Registration Area.

The HPLMN also makes it possible to provide the UE 10 with information regarding Tracking Areas that support the Rejected S-NSSAI. For example, a set of the HPLMN_TA1 and HPLMN_TA4 is provided with regard to the S-NSSAI-H2, the HPLMN_TA1 is provided with regard to the S-NSSAI-H3, and the HPLMN_TA3 is provided with regard to the S-NSSAI-H4.

In a case where the UE 10 acquires information regarding a Tracking Area that supports the Rejected S-NSSAI, the UE 10 makes it possible to request registration of the Rejected S-NSSAI again in the Tracking Area that supports the Rejected S-NSSAI, even within the Registration Area.

Alternatively, the HPLMN may provide the UE 10 with information regarding Tracking Areas that do not support the Rejected S-NSSAI, for example, a set of the HPLMN_TA2 and HPLMN_TA3 is provided with regard to the S-NSSAI-H2, a set of the HPLMN_TA2, HPLMN_TA3, and HPLMN_TA4 is provided with regard to the S-NSSAI-H3, and the HPLMN_TA1, HPLMN_TA2, and HPLMN_TA4 is provided with regard to the S-NSSAI-H4.

In a case where the UE 10 acquires information regarding a Tracking Area that does not support the Rejected S-NSSAI, the UE 10 makes it possible to request registration of the Rejected S-NSSAI again in a Tracking Area other than the tracking Area that does not support the Rejected S-NSSAI, that is, a Tracking Area that supports the Rejected S-NSSAI, even within the Registration Area.

When the UE 10 acquires information regarding the Tracking Area of the Rejected S-NSSAI, the UE 10 may receive information that explicitly indicates whether the information is information regarding a Tracking Area that supports the Rejected S-NSSAI or information regarding a Tracking Area that does not support the Rejected S-NSSAI.

The 5GC 30 may decide which information to transmit to the UE 10 depending on the size of information regarding Tracking Areas that support the Rejected S-NSSAI and the size of information regarding Tracking Areas that do not support the Rejected S-NSSAI. For example, in a case where the size of the information regarding Tracking Areas that support the Rejected S-NSSAI is smaller than the size of the information regarding Tracking Areas that do not support the Rejected S-NSSAI, the 5GC 30 transmits the information regarding Tracking Areas that support the Rejected S-NSSAI. In a case where the size of the information regarding Tracking Areas that support the Rejected S-NSSAI is larger than the size of the information regarding Tracking Areas that do not support the Rejected S-NSSAI, the 5GC 30 transmits information regarding Tracking Areas that do not support the Rejected S-NSSAI.

The HPLMN may also create second Allowed NSSAI or Conditionally Allowed NSSAI and provide it to the UE 10 during the registration process. The second Allowed NSSAI or the Conditionally Allowed NSSAI includes information regarding one or more S-NSSAIs and Tracking Areas that allow registration of the S-NSSAIs. For example, the second Allowed NSSAI or Conditionally Allowed NSSAI includes a set of the S-NSSAI-H2, S-NSSAI-H3, and S-NSSAI-H4, a set of the HPLMN_TA1 and HPLMN_TA4 as Tracking Areas that allow registration of the S-NSSAI-H2, the HPLMN_TA1 as a Tracking Area that allows registration of the S-NSSAI-H3, and the HPLMN_TA3 as a Tracking Area that allows registration of the S-NSSAI-H4.

In a case where the UE 10 acquires the second Allowed NSSAI or the Conditionally Allowed NSSAI, it is possible to transmit a PDU session establishment request message including the S-NSSAI to the HPLMN serving as the serving network, in each Tracking Area that allows registration of the S-NSSAI included in the second Allowed NSSAI or the Conditionally Allowed NSSAI.

The 5GC 30 may provide the UE 10 with the second Allowed NSSAI or the Conditionally Allowed NSSAI in addition to the Allowed NSSAI, or may provide the UE 10 with the Conditionally Allowed NSSAI as the Allowed NSSAI. Here, in a case of providing the Conditionally Allowed NSSAI as the Allowed NSSAI, information indicating that it is available in all Tracking Areas, such as “all”, is added to S-NSSAI that is available in all Tracking Areas of the Registration Area of the Conditionally Allowed NSSAI, as information regarding the Tracking Area.

Whether to provide the UE 10 with the second Allowed NSSAI or the Conditionally Allowed NSSAI in addition to the Allowed NSSAI, or to provide the UE 10 with the Conditionally Allowed NSSAI as the Allowed NSSAI may be set for each generation of the public land mobile network system (for example, 5G, 5G-Advanced, or 6G) and even for each release of each generation.

Alternatively, the 5GC 30 may provide the UE 10 with information that explicitly indicates whether to provide the UE 10 with the second Allowed NSSAI or the Conditionally Allowed NSSAI in addition to the Allowed NSSAI, or to provide the Conditionally Allowed NSSAI as the Allowed NSSAI.

Furthermore, in a case where a network slice that is available only in a Tracking Area supporting a specific frequency band is set, the AMF 301 makes it possible to decide a Target NSSAI in such a manner that the UE 10 can be guided to a cell or Tracking Area that operates on that frequency. The AMF 301 may cooperate with the NSSF 304 when deciding the Target NSSAI. Here, the Tracking Area supporting the specific frequency band may be set within the HPLMN_TA1, HPLMN_TA2, HPLMN_TA3, or HPLMN_TA4, may be set separately from the HPLMN_TA1, HPLMN_TA2, HPLMN_TA3, or HPLMN_TA4 to overlap with the HPLMN_TA1, HPLMN_TA2, HPLMN_TA3, or HPLMN_TA4, or may be set to be an Area of Service (AoS) (to be described later).

The AMF 301 acquires an RAT/Frequency Selection Priority Index (RESP index) suitable for the Target NSSAI from the PCF 305 and transmits information including the RESP index to the (R)AN 20 via the reference point N2. In a case where the PCF 305 is not installed, the AMF 301 decides the RFSP index in accordance with locally set rules. To apply an individual radio resource management policy taking available information into consideration, the (R)AN 20 maps the RFSP index to locally defined settings. That is, the (R)AN 20 makes it possible to select settings for the radio resource management policy suitable for the Target NSSAI corresponding to the RFSP index.

The RESP index is used to control the priority of UE-specific measurement frequencies for a cell reselection process in an idle mode (for example, RRC IDLE) or to redirect the UE 10 in an active mode (for example, RRC CONNECTED) to a cell, beam, or an RAT operating on a different frequency.

The HPLMN makes it possible to set the RFSP index in consideration of the Subscribed NSSAI. The AMF 301 acquires a Subscribed RFSP index from the UDM 307, for example, during the registration process.

The AMF 301 uses:
an RESP index that is the same as the Subscribed RESP index; and
an RESP index selected on the basis of the Subscribed RESP index, a locally defined operator policy, Allowed NSSAI, and context information related to the UE 10 that are available in the AMF 301.

The (R)AN 20 makes it possible to acquire the Target NSSAI from the AMF 301 and guide the UE 10 to a cell that supports a network slice identified by the S-NSSAI included in the Target NSSAI.

It is possible for the Target NSSAI to include at least one S-NSSAI that is not available in the current Tracking Area but is available in another Tracking Area in a different frequency band, among the Requested NSSAIs. It is also possible for the Target NSSAI to additionally include an S-NSSAI that is available in the other Tracking Area as an S-NSSAI that is not available in the current Tracking Area.

In other words, it is possible for the Target NSSAI to include:
some of the S-NSSAI(s) or all the Rejected S-NSSAI(s) in the Registration Area in a case where all S-NSSAIs of the Requested NSSAI are not available in a Tracking Area on which the UE 10 currently camps;
All the S-NSSAI(s) of the Allowed NSSAI and all the Rejected S-NSSAI(s) in the Registration Area or some of the S-NSSAI(s);
S-NSSAI(s) that are some of the Allowed NSSAI and, in a case where the operator policy selects a Target NSSAI from the Allowed NSSAI, some of the S-NSSAI(s) or all the Rejected S-NSSAI(s) in the Registration Area.

When the (R)AN 20 makes it possible to redirect the UE 10 to a new Tracking Area outside the Registration Area, an RESP index associated with the Target NSSAI is taken into consideration, otherwise an RFSP index of the Allowed NSSAI is taken into consideration.

The (R)AN 20 has to control the UE 10 in such a manner that it is possible to find a cell in a Tracking Area that is able to support all S-NSSAI(s) of the Target NSSAI. When such a cell is not found, the (R)AN 20 makes it possible to control the UE 10 in such a manner that it is possible to select a cell in a Tracking Area that most closely matches the Target NSSAI. Here, the tracking area that most closely matches the Target NSSAI is, for example, a Tracking Area that makes it possible to support more S-NSSAI(s) of the Target NSSAI. Alternatively, in a case where it has information regarding the priority of the S-NSSAI(s) of the Target NSSAI, the Tracking Area that most closely matches the Target NSSAI is a Tracking Area that makes it possible support more S-NSSAI(s) having higher priority.

After successful redirection to the new Tracking Area outside the Registration Area, the UE 10 has to execute a Mobility Registration Update procedure. To enable the redirection to the new Tracking Area outside the Registration Area, the Mobility Registration Update procedure has to be started in such a manner that the UE 10 makes it possible to request registration of S-NSSAI(s) whose registration has been rejected in the Registration Area. When providing the Target NSSAI to the (R)AN 20, the AMF 301 has to set a Registration Area that does not include any Tracking Area where registration of the S-NSSAI(s) included in the Target NSSAI is rejected.

The AMF 301 may also define a Tracking Area that supports network slices available only in a specific frequency band within the Registration Area, as a Tracking Area that is available only for Dual Connectivity (DC) or Carrier Aggregation (CA) operation. Here, the Dual Connectivity and Carrier Aggregation may be collectively referred to as Multi-Connectivity (MC).

The (R)AN 20 makes it possible to control the UE 10 in such a manner that a particular Tracking Area is taken into consideration only through cell selection/reselection of a Secondary Cell Group (SCG) of the Dual Connectivity or cell selection/reselection of a Secondary Cell (SCell) of the Carrier Aggregation in accordance with the RFSP index and the settings for the radio resource management policy corresponding to the RFSP index.

Furthermore, the AMF 301 may makes it possible to allow registration of a network slice (S-NSSAI) that is only available for the Dual Connectivity or Carrier Aggregation operation, and include a Tracking Area where the network slice (S-NSSAI) is available, into the registration area. Next, the AMF 301 may include the network slice (S-NSSAI) that is only available for the Dual Connectivity or Carrier Aggregation operation, into the Allowed NSSAI.

On the basis of the UE Radio Capability Information, the AMF 301 determines whether to register a network slice (S-NSSAI) that is only available for the Dual Connectivity or Carrier Aggregation operation. For example, when the UE 10 supports the Dual Connectivity or Carrier Aggregation, registration of the network slice (S-NSSAI) is allowed. When the UE 10 does not support the Dual Connectivity or Carrier Aggregation, the registration is rejected. In addition, when the UE 10 supports operation frequency of a cell of the Secondary Cell Group (SCG) for the Dual Connectivity or operation frequency of the Secondary Cell (SCell) for the Carrier Aggregation, registration of the network slice (S-NSSAI) is allowed. When the UE 10 does not support the operation frequency of the cell of the SCG for the Dual Connectivity or the operation frequency of the SCell for the Carrier Aggregation, the registration is rejected.

The AMF 301 may transmit information regarding Tracking Areas within a Registration Area to the (R)AN 20 as supplemental information or assistance information regarding the Allowed NSSAI. Here, the information regarding Tracking Areas within the Registration Area includes information indicating whether a cell of each Tracking Area included in the Registration Area is a cell that is taken into consideration only through cell selection/reselection of an SCG of the Dual Connectivity or cell selection/reselection of an SCell of the Carrier Aggregation.

The Allowed NSSAI and the information regarding the Tracking Area within the Registration Area are transmitted to the UE 10 via the (R)AN 20.

In addition, the AMF 301 may transmit Network Slice AS Group (NSAG) information to the UE 10 as information regarding cell selection/reselection for each S-NSSAI included in the allowed NSSAI.

The NSAG information includes information indicating whether the network slice is available only in the Dual Connectivity or Carrier Aggregation operation.

Furthermore, in a case of the network slice (S-NSSAI) that is only available in the Dual connectivity operation, it includes priorities of candidate frequencies of cells in a Master Cell Group (MCG), priorities of candidate frequencies of cells in the SCG, and the like.

In a case of network slices (S-NSSAI) that is only available in the Carrier Aggregation operation, it includes priorities of candidate frequencies of Primary Cells (PCells), priorities of candidate frequencies of the SCells, and the like.

The UE 10 establishes a PDU session via a cell of the MCG for a network slice to use the network slice that is only available in the Dual Connectivity operation on the basis of the Allowed NSSAI and information regarding the Tracking Area in the Registration Area, and/or the NSAG information. Here, a base station that provides the cell of the MCG is referred to as a Master Node (MN).

With regard to the UE 10, the (R)AN 20 configures measurement of SCG cells supporting network slices only available in the Dual Connectivity operation in accordance with the RESP index and the radio resource management policy corresponding to the RESP index, and the UE 10 transmits measurement results of the SCG cells to the MCG cells. The measurement of the SCG cells is configured through the RRC. Here, a base station that provides the SCG cells is referred to as a Secondary Node). The MCG cell establishes the Dual Connectivity by transmitting an SN Addition Request to the SCG cells on the basis of the measurement results of the SCG cells acquired from the UE 10.

With the establishment of the dual Connectivity, the MCG cell transmits a PDU Session Modification Indication to the AMF 301 during the PDU Session Path Update procedure.

The UE 10 establishes a PDU session via a PCell for a network slice to use the network slice that is only available in the Carrier Aggregation operation on the basis of the Allowed NSSAI and information regarding the Tracking Area in the Registration Area.

With regard to the UE 10, the (R)AN 20 configures measurement of SCells supporting network slices only available in the Carrier Aggregation operation in accordance with the RFSP index and the radio resource management policy corresponding to the RESP index, and the UE 10 transmits measurement results of the SCells to the PCells. The measurement of the SCells is configured through the RRC.

The PCell adds the SCell for Carrier Aggregation through the RRC on the basis of the measurement results of the SCell acquired from the UE 10.

Furthermore, one of requirements for network slices is to ensure isolation between the network slices. In particular, in a case of supporting a plurality of network slices in limited radio resources, admission control is applied to prevent congestion in each network slice in such a manner that other network slices are not affected.

The NSACF 312 monitors and controls the number of UEs 10 registered for each network slice, the number of established PDU sessions, and the number of UEs 10 that have established one or more PDU sessions. The NSACF 312 also supports notifications and reports of statuses of network slices in response to events to each NF.

### 4. Admission Control of Network Slice

To control the number of UEs 10 registered for each network slice, the AMF 301 sets a validity period for a registered network slice in accordance with the status of a network slice notified or reported by the NSACF 312. Examples of the status of the network slice include the number of UEs 10 registered for a target S-NSSAI, the number of PDU sessions established using the target S-NSSAI, the number of UEs 10 each having established one or more PDU sessions using the target S-NSSAI, a state where the number of UEs 10 registered for the target S-NSSAI exceeds a preset threshold, a state where the number of PDU sessions established using the target S-NSSAI exceeds a preset threshold, and a state where the number of UEs 10 each having established one or more PDU sessions using the target S-NSSAI exceeds a preset threshold. The validity period is set for the registered network slice in accordance with such a status of the network slice.

The AMF 301 sets validity periods for all or some of the S-NSSAIs included in the Allowed NSSAI, and provides the UE 10 with Allowed NSSAIs in which validity periods are set for all or some of the S-NSSAIs as a set of registered network slices. Here, the AMF 301 may provide the UE 10 with information regarding the validity periods of all or some of the S-NSSAIs in the Allowed NSSAI by including the information into the Allowed NSSAI or as supplemental information (or assistance information) regarding the Allowed NSSAI.

When the UE 10 acquires Allowed NSSAI in which validity periods are set for all or some of the S-NSSAIs or acquires Allowed NSSAI and supplemental information regarding the Allowed NSSAI, a timer starts on the basis of the validity period set for the S-NSSAIs. Next, when a validity period of the timer expires, the UE 10 deletes S-NSSAI whose validity period has expired from the Allowed NSSAI. Here, in a case where the U E10 establishes a PDU session using an S-NSSAI for which a validity period is set, the timer stops while the PDU session is established. Next, when releasing the PDU session, the timer gets reset and starts again. In other words, the timer works only while a network slice related to the S-NSSAI for which a validity period is set is not being used.

In addition, the AMF 301 may set validity periods of all or part of the S-NSSAIs included in its own Allowed NSSAI depending on a status of a network slice notified or reported by the NSACF 312, and may update the Allowed NSSAI or supplemental information regarding the Allowed NSSAI.

When the Allowed NSSAI or the supplemental information regarding the Allowed NSSAI is updated, the AMF 301 provides the UE 10 with the updated Allowed NSSAI or the updated supplemental information regarding the Allowed NSSAI.

In addition, at a time of the registration process, the NSSF 304, that has obtained information regarding the Requested NSSAI from the AMF 301 may set validity periods for all or some of the S-NSSAIs included in the Allowed NSSAI depending on a status of a network slice notified or reported by the NSACF 312.

The NSSF 304 may provide the AMF 301 with information regarding the validity periods of all or some of the S-NSSAIs in the Allowed NSSAI by including the information into the Allowed NSSAI or as supplemental information regarding the Allowed NSSAI.

Furthermore, the AMF 301 provides the UE 10 with information regarding conditions for re-registration of a target S-NSSAI (deleted S-NSSAI) when the target S-NSSAI is deleted from the Allowed NSSAI due to expiration of the validity period. Here, the conditions are, for example, a condition that a request for re-registration is prohibited in a same Registration Area, in a same Tracking Area (mobility management area), or in a same Area of Service (AoS), a condition that a backoff timer is set until reregistration in the same Registration Area, the same Tracking Area, or the same AoS, or other conditions. These conditions are decided, for example, by the NSAC F312, NSSF 304, or AMF 301. Here, the Aos is an area defined at a finer granularity than the Tracking Area, for example, a region defined by a coordinate system such as latitude and longitude, a cell ID, a set of cell IDs, a base station ID, or a set of base station IDs.

In a case where the condition prohibits a request for reregistration in the same Registration Area, the same Tracking Area, or the same AoS, the UE 10 may be notified of an instruction to treat the target S-NSSAI (the deleted S-NSSAI) as a Rejected S-NSSAI or an instruction to add it to the Rejected NSSAI.

In a case where the condition sets a backoff timer until reregistration in the same Registration Area, the same Tracking Area, or the same AoS, the UE 10 may be notified of an instruction to treat the target S-NSSAI (the deleted S-NSSAI) as a Pending S-NSSAI during a backoff period until the reregistration, or an instruction to add it to the Pending NSSAI.

The UE 10 may also include information regarding priority of each S-NSSAI into the registration request message as supplemental information (or assistance information) of the Requested NSSAI.

The NSSF 304 determines whether to allow registration of S-NSSAI included in the Requested NSSAI on the basis of information notified or reported by the NSACF 312 such as the number of registered UEs 10, the number of established PDU sessions, and/or the number of UEs 10 that have established one or more PDU sessions, and priority of registration of each S-NSSAI included in the supplemental information regarding the Requested NSSAI. For example, registration of an S-NSSAI having high priority of registration is allowed, and registration of an S-NSSAI having low priority of registration is rejected. Here, the priority of registration of each S-NSSAI may be a level depending on urgency. For example, registration of an S-NSSAI having high urgency of registration, that is, high priority of registration is allowed, and registration of an S-NSSAI having low urgency priority of registration, that is, low priority of registration is rejected.

Furthermore, the NSSF 304 or the AMF 301 may decide the validity period of each S-NSSAI whose registration is to be allowed on the basis of the number of registered UEs 10, the number of established PDU sessions, and/or the number of UEs 10 that have established one or more PDU sessions, and the priority of registration of each S-NSSAI included in the supplemental information regarding the Requested NSSAI. For example, a long validity period is assigned to an S-NSSAI having high priority of registration, and a short validity period is assigned to an S-NSSAI having low priority of registration.

The AMF 301 sets a validity period for each S-NSSAI whose registration is to be allowed on the basis of information that is acquired from the NSSF 304 and that relates to a validity period of each S-NSSAI whose registration is to be allowed, or on the basis of a validity period assigned by the AMF 301 itself.

### 5. Location Information Management Function

In a UE-Based mode, the UE 10 makes it possible to acquire assistance data for positioning from the LMF 312 and perform measurement and location calculation with regard to a Global Navigation Satellite System (GNSS). It is possible for the UE 10 to use, for example, a widely known method referred to as Assisted-GNSS.

Note that, in a case where any signal is not received from GNSS or in other cases, the UE 10 may detect location information through means other than the GNSS. For example, the UE 10 makes it possible to detect information regarding its own location by using a method referred to as sidelink positioning, WLAN positioning, Bluetooth (registered trademark) positioning, or Terrestrial Beacon System (TBS) positioning.

In the sidelink positioning, the UE 10 measures a Sidelink Received Signal Strength Indicator (SL RSSI) through sidelink communication with surrounding UEs 10 or Roadside Units (RSUs). The UE 10 calculates its location on the basis of information regarding locations of the respective UEs 10 or the Roadside Units and a measurement value of the SL RSSI. Furthermore, the UE 10 may measure round-trip time (RTT) between the UE 10 and the surrounding UEs 10 or the Roadside Units and calculate its location.

In the WLAN positioning, the UE 10 measures a Received Signal Strength Indicator (RSSI) related to each WLAN Access Point. The UE 10 calculates its location on the basis of information regarding known coordinates of the respective WLAN Access Points and their measurement values. Additionally, the UE 10 may measure RTT between the UE 10 and the WLAN Access Points and calculate its location.

In the Bluetooth positioning, the UE 10 may measure an RSSI for each Bluetooth beacon and calculate its location on the basis of information regarding known coordinates of the respective Bluetooth beacons and their measurement values.

In a case where the UE 10 is equipped with a GNSS receiver, the UE 10 performs measurement with regard to the GNSS such as measurement of Code Phase, Doppler, Carrier Phase, or the like in a UE-Assisted mode. The UE 10 transmits such a measurement value to the LMF 312, and the LMF 312 calculates the location of the UE 10.

In addition, in a case where the UE 10 is equipped with the GNSS receiver but fails to receive signals from the GNSS, or in a case where the UE 10 is not equipped with the GNSS, the LMF 312 may acquire information regarding the location of the UE 10 through a positioning technique referred to as the following:
OTDOA (Observed Time Difference Of Arrival);
Multi-RTT;
DL AoD (Downlink Angle-of-Departure);
DL TDOA (Downlink Time Difference of Arrival);
UL TDOA (Uplink Time Difference of Arrival); or
UL AoA (Angle of Arrival).
   Alternatively, the LMF 312 may acquire the information regarding the location of the UE 10 through a positioning technique using a Cell ID (CID).

For example, in a case of the OTDOA, the UE 10 receives downlink Positioning Reference Signals (PRSs) from a plurality of Transmission Points (TPs) and reports a Physical cell ID, a Global cell ID, TP IDs and a measurement values related to timings of the PRSs to the LMF 312 through an LTE Positioning Protocol (LPP). Therefore, the LMF 312 calculates the location of the UE 10 on the basis of information regarding known coordinates of the respective measured TPs and relative timings of the reported PRSs.

Also, for example, in a case of the positioning technique using the CID, the LMF 312 calculates the location of the UE 10 on the basis of information regarding known coordinates of the ng-eNB or gNB and a measurement result (to be described later) reported by the UE 10.

The UE 10 reports, to the LMF 312, an Evolved Cell Global Identifier (ECGI) or the Physical Cell ID, and measurement results of Reference Signal Received Power (RSRP), Reference Signal Received Quality (RSRQ) and UE Rx-Tx time difference, for example. Here, the UE Rx-Tx time difference is defined as a time difference between a timing of reception and a timing of transmission by the UE 10.

### 6. First Method of Improving Availability of Network Slice

In the example of network slice deployment illustrated in FIG. 5, the UE 10 is not allowed to use the S-NSSAI-H2 in the HPLMN_TA2, for example. That is, by enabling the UE 10 to use the S-NSSAI-H2 in the HPLMN_TA2, it is possible to improve the availability of network slices.

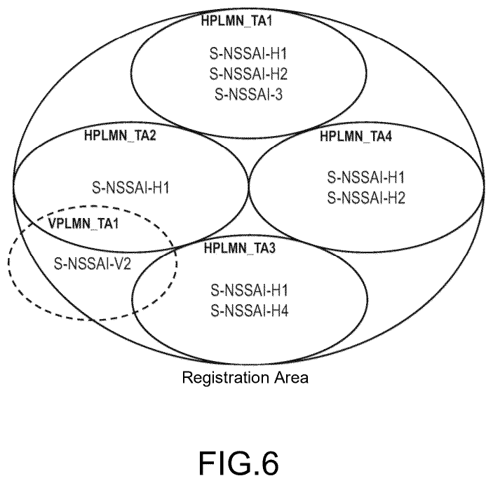

FIG. 6 is a diagram illustrating another example of network slice deployment of the 5GS. Here, the HPLMN has a roaming SLA with a VPLMN that is another PLMN.

The UE 10 makes it possible to identify a VPLMNs where the roaming is possible, by possessing an Equivalent PLMN (EPLMN) list or an Equivalent HPLMN (EHPLMN) list that include PLMN IDs of VPLMNs.

The VPLMN supports an S-NSSAI-V2 in a VPLMN_TA1. The VPLMN_TA1 overlaps with a part of the HPLMN_TA2 and a part of the HPLMN_TA3 as illustrated in FIG. 6, for example. It is assumed that a region where the VPLMN makes it possible to support the S-NSSAI-V2 in the HPLMN_TA2 is an Area of Service (AoS) of the S-NSSAI-V2 in the HPLMN_TA2. Similarly, it is assumed that a region where the VPLMN makes it possible to support the S-NSSAI-V2 in the HPLMN_TA3 is an AoS of the S-NSSAI-V2 in the HPLMN_TA3.

To improve availability of the HPLMN for the Rejected S-NSSAI, the HPLMN provides the UE 10 with the PLMN ID of the VPLMN, information regarding the Aos, and information regarding mapping of a value of the Rejected S-NSSAI in the HPLMN and a corresponding value of the S-NSSAI used in the VPLMN, as a part of the information regarding the Tracking Area that supports the above-described Rejected S-NSSAI or as supplemental information. For example, the information regarding the AOS is a set of the HPLMN_TA2 and the VPLMN_TA1, and the information regarding the mapping is information indicating a correspondence relation between the S-NSSAI-H2 and the S-NSSAI-V2.

On the basis of the PLMN IDs of the VPLMN, the information regarding the AoS, and the information regarding the mapping, the UE 10 makes it possible to determine that the VPLMN Serves as a serving PLMN and is in the Aos region of the S-NSSAI-H2 of the HPLMN when the UE 10 camps on the HPLMN_TA2 and the VPLMN_TA1.

### 6.1 Determination of Rejected S-NSSAI

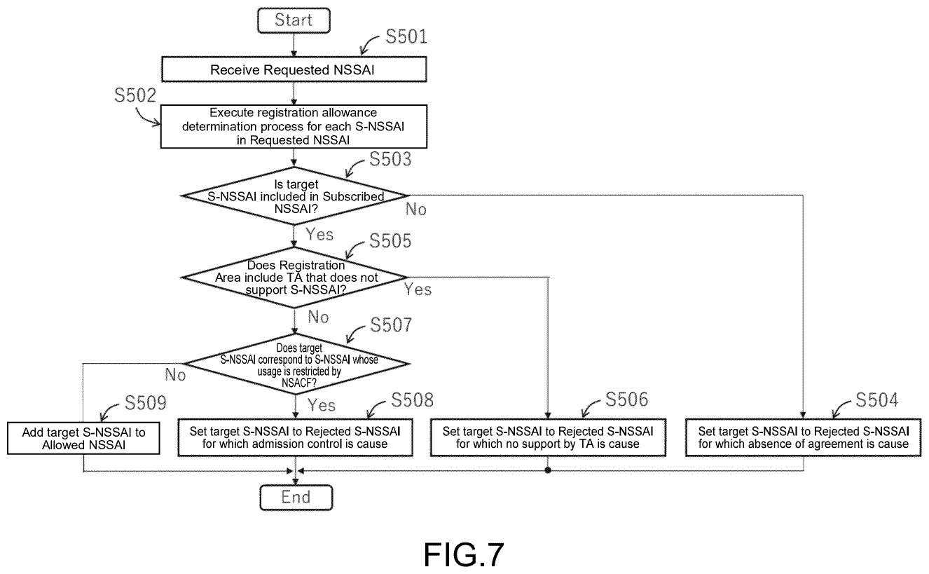

FIG. 7 is a diagram illustrating an example of a network slice registration determination process in the registration process.

When the NSSF 304 receives Requested NSSAI from the UE 10 via the (R)AN 20 and the AMF 301 (step S501), the NSSF 304 executes a registration allowance determination process for each S-NSSAI included in the Requested NSSAI (step S502).

The NSSF 304 that has acquired information regarding the Requested NSSAI via the AMF 301 refers to subscriber information held and managed by the UDR of the UDM 307 to check whether a target S-NSSAI is included in a Subscribed NSSAI (step S503). When the target S-NSSAI is not included, the NSSF 304 sets the determination target S-NSSAI to Rejected S-NSSAI for which absence of agreement is a cause (S504).

In step S503, when the determination target S-NSSAI is included in the Subscribed NSSAI, the NSSF 304 determines whether a Registration Area includes a Tracking Area that does not support the determination target S-NSSAI (step S505). When the Registration Area includes the Tracking Area that does not support the determination target S-NSSAI, the NSSF 304 sets the determination target S-NSSAI to Rejected S-NSSAI for which no support by the Tracking Area is the cause (S506).

In step S505, when the Registration Area does not include the Tracking Area that does not support the determination target S-NSSAI, that is, when all the Tracking Areas in the Registration Area support the determination target S-NSSAI, the NSSF 304 checks whether the determination target S-NSSAI is an S-NSSAI whose usage is restricted by the NSACF 312 (step S507). When the determination target S-NSSAI is the S-NSSAI whose usage is restricted by the NSACF 312, the NSSF 304 sets the determination target S-NSSAI to Rejected S-NSSAI for which its admission control is the cause (step S508). Here, the NSSF 304 may determine whether the determination target S-NSSAI is the S-NSSAI whose usage is restricted, on the basis of a status of a network slice notified or reported from the NSACF 312.

In step S507, when the determination target S-NSSAI is not the S-NSSAI whose usage is restricted by the NSACF 312, the NSSF 304 adds the determination target S-NSSAI to Allowed NSSAI (step S509).

In addition, the NSSF 304 may determine whether to allow registration on the basis of UE Radio Capability Information, in a case where the determination target S-NSSAI requests specific UE Radio capability. Alternatively, on the basis of the UE Radio Capability Information, the AMF 301 may further determine whether to allow registration with regard to S-NSSAI(s) for which the NSSF 304 has determined that the registration is allowed.

Note that, some or all of the processes illustrated in FIG. 7 may be executed by the AMF 301 instead of the NSSF 304.

### 6.2 Creation of Supplemental Information Regarding Rejected S-NSSAI

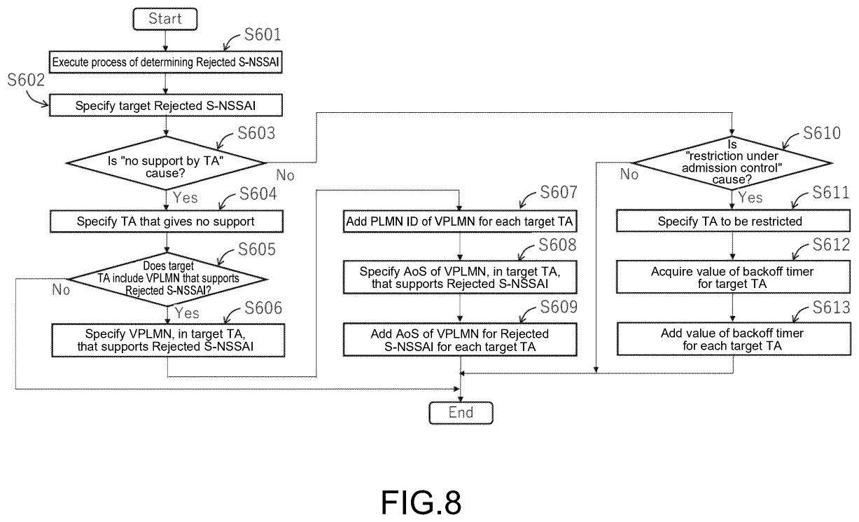

FIG. 8 is a diagram illustrating an example of a process of creating supplemental information regarding Rejected S-NSSAI in the registration process.

A process of determining whether the Rejected S-NSSAI has been set in the above-described registration determination process illustrated in FIG. 7 is executed (step S601). In a case where the Rejected S-NSSAI has been set, target Rejected S-NSSAI is specified from among the set Rejected S-NSSAIs (step S602). As an example, all the Rejected S-NSSAIs that have been set are specified as the target Rejected S-NSSAIs.

With regard to the specified Rejected S-NSSAI, the AMF 301 checks whether the “no support by the Tracking Area” is the cause for rejection of registration (step S603). When the “no support by the Tracking Area” is the cause, the Tracking Area where the Rejected S-NSSAI is not supported is specified (step S604).

The AMF 301 checks whether the specified target Tracking Area includes a Visitor PLMN (VPLMN) that supports the Rejected S-NSSAI (step S605). When the target Tracking Area includes the VPLMN that supports the Rejected S-NSSAI, the AMF 301 specifies the VPLMN, in the target Tracking Area, that supports Rejected S-NSSAI (step S606), and adds a PLMN ID of the VPLMN in each target Tracking Area, to the supplemental information (or assistance information) regarding the Rejected S-NSSAI (step S607).

Next, the AMF 301 specifies an AoS of the VPLMN, in the target Tracking Area, that supports the Rejected S-NSSAI (step S608), adds information for specifying the AoS of the VPLMN in each target Tracking Area to the supplemental information regarding the Rejected S-NSSAI (step S609), and ends the process. Here, the AoS of the VPLMN is, for example, a region defined by a coordinate system such as latitude and longitude, a Tracking Area (mobility management area) set by the VPLMN, a cell ID, a set of cell IDs, a base station ID, a set of base station IDs, or the like. In addition, the information regarding the Aos may include information regarding a frequency band or a BandWidth Part (BWP) that support the Rejected S-NSSAI in the AoS. In this case, the UE 10 determines that the Rejected S-NSSAI is available only via the frequency band or BWP specified in the AoS. Here, the Aos is an example of a service region according to the present embodiment.

In addition, in step S609, the supplemental information regarding the Rejected S-NSSAI may include information explicitly indicating that transmission of a registration request of the Rejected S-NSSAI to the VPLMN is allowed in the AoS of the VPLMN.

Furthermore, in a case where a plurality of VPLMNs are specified in step S606, priorities may be assigned to the VPLMNs on the basis of the AoS of the VPLMNs specified in step S606. In step S609, information regarding the priorities of the VPLMNs may be added to the supplemental information regarding the Rejected S-NSSAI. For example, a higher priority is assigned to a VPLMN having a wider AoS, and a lower priority is assigned to a VPLMN having a narrower AoS. Alternatively, a higher priority is assigned to a VPLMN having a wider frequency bandwidth covering the AOS, and a lower priority is assigned to a VPLMN having a narrower frequency bandwidth covering the AoS. Alternatively, in a case where a validity period is set for the Aos, a higher priority is assigned to a VPLMN whose AoS has a longer validity period, and a lower priority is assigned to a VPLMN whose AoS has a shorter validity period.

The UE 10 that has acquired the supplemental information regarding the Rejected S-NSSAI makes it possible to select a VPLMN that supports the Rejected S-NSSAI in the target Tracking Area on the basis of such priorities.

On the other hand, in a case where the “no support by the Tracking Area” is not the cause in step S603, the AMF 301 further checks whether “restriction under admission control” is the cause for rejection of registration (step S610). When the “restriction under admission control” is the cause, a Tracking Area to be restricted is specified (step S611).

The AMF 301 acquires a value of the backoff timer from the NSACF 312 (step S612). This value indicates a period until a reregistration request of the Rejected S-NSSAI is allowed with regard to the specified Tracking Area. Then, the AMF 301 adds the value of the backoff timer of each target Tracking Area to the supplemental information regarding the Rejected S-NSSAI (step S613), and ends the process.

In step S612, thee AMF 301 may set a value of the backoff timer depending on a status of a network slice notified or reported by the NSAC F312.

Here, in the step S613, the supplemental information regarding the Rejected S-NSSAI may include information explicitly indicating that transmission of the reregistration request of the Rejected S-NSSAI is allowed in a target Tracking Area of the HPLMN after the set backoff timer expires.

In addition, in a case where the Rejected S-NSSAI is an S-NSSAI having a high priority of registration, the processes in the step S605 and subsequent steps may be added after the processing in the step S613.

Also, the process ends in a case where the “restriction under admission control” is not the cause in the step S610, or in a case where the target Tracking Area does not include the VPLMN that supports the Rejected S-NSSAI in the step S605.

Furthermore, in a case where the plurality of VPLMNs that support the Rejected S-NSSAI is specified in the step S606, the supplemental information regarding the Rejected S-NSSAI may include priorities for PLMN selection. The supplemental information regarding the Rejected S-NSSAI may further include an instruction to set the priorities in the EPLMN list or the EHPLMN list.

The priority may also be set depending on the size of the Aos of the VPLMN that supports the Rejected S-NSSAI. For example, priority of a VPLMN having a larger AoS may be set to high, and priority of a VPLMN having a smaller AoS may be set to low.

Furthermore, the priority may be set depending on a status of a network slice notified or reported by a NSACF 312-2 of the VPLMN. For example, the priority is set depending on the number of UEs 10 registered in a network slice serving as a target of the VPLMN, the number of PDU sessions established by using the network slice serving as the target of the VPLMN, or the number of UEs 10 that have established one or more PDU sessions by using the network slice serving as the target of the VPLMN. High priority is given to A VPLMN where the number of registered UEs 10, the number of PDU sessions, or the number of UEs 10 that have established one or more PDU sessions is smaller. Low priority is given to a VPLMN where the number of registered UEs 10, the number of PDU sessions, or the number of UEs 10 that have established one or more PDU sessions is larger.

FIG. 8 illustrates the example in which the AMF 301 creates the supplemental information regarding the Rejected S-NSSAI. However, the function that executes such processes is not limited to the AMF 301. It is also possible for another NF in the 5GC 30 to create the supplemental information regarding the Rejected S-NSSAI. For example, when an Nnssf_NSSelection_Get message is received from the AMF 301 and Allowed NSSAI is created, the NSSF 304 may create the Rejected S-NSSAI and the supplemental information. The NSSF 304 replies, to the AMF 301, an Nnssf_NSSelection_Get response message including the Allowed NSSAI, Rejected S-NSSAI, and supplemental information regarding the Rejected S-NSSAI.

### 6.3 Registration Process

To receive services via the 5GC/NGC 30, the UE 10 has to register for a network (such as a RAN, AN, or core network) in accordance with any of the following purposes: Initial Registration for the 5GS; Mobility Registration Update with a switch to a new Tracking Area outside the Registration Area; Periodic Registration update; and Emergency Registration. The UE 10 selects, for example, a PLMN corresponding to the 5GC 30 and executes a registration process.

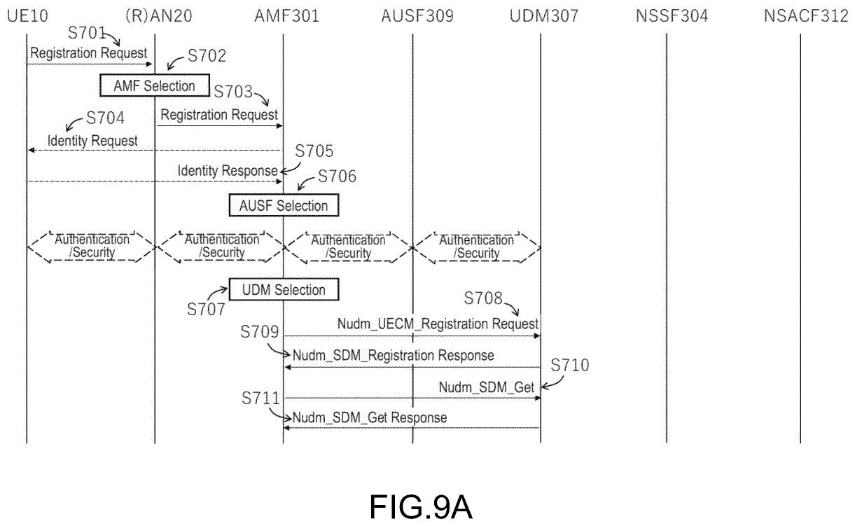

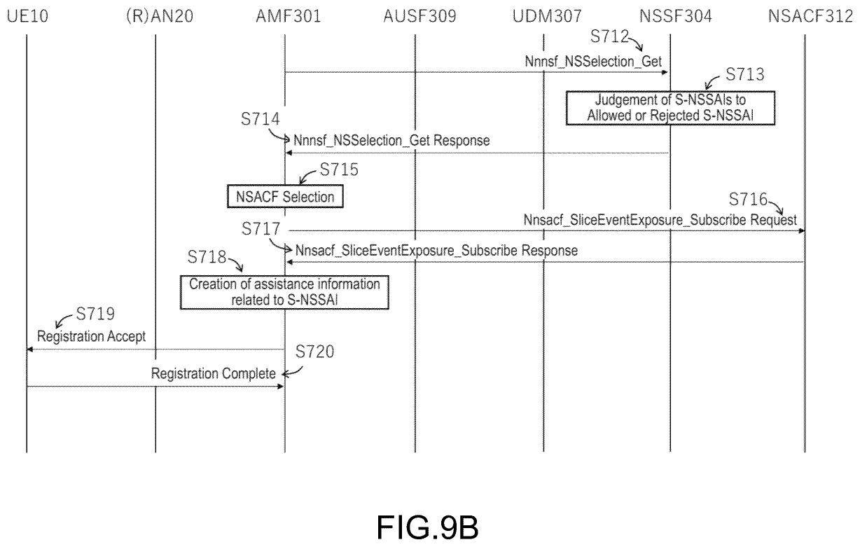

FIG. 9A and FIG. 9B are diagrams illustrating an example of the registration process to the 5GS. FIG. 9A and FIG. 9B are diagrams illustrating an example of a registration procedure. As illustrated in FIG. 9A, the UE 10 in an RM-DEREGISTERED state, i.e., the UE 10 that is not registered with the 5GC 30, transmits a Registration Request message to the (R)AN 20 to execute Initial Registration (step S701). At this time, the UE 10 includes its UE identity into the Registration Request message and transmits it.

In a case of having a valid EPS Global Unique Temporary Identifier (GUTI), the UE identity is a 5G-GUTI mapped from the EPS GUTI. Here, the EPS (Evolved Packet System) means a 4G system corresponding to long-term evolution (LTE) and includes an Evolved UMTS Terrestrial Radio Access Network (EUTRAN) and an Evolved Packet Core (EPC). From a security perspective, the EPS GUTI is a temporary ID to be used to identify the UE 10 in the EPS, instead of an ID uniquely assigned to each UE such as an International Mobile Subscriber Identity (IMSI) or an International Mobile Equipment Identity (IMEI) .

Alternatively, the UE identity is a PLMN-specific 5G-GUTI assigned by a PLMN for which the UE10 is attempting to register, if available.

Alternatively, the UE identity is a PLMN-specific 5G-GUTI assigned by a PLMM that is treated as an equivalent PLMN to the PLMN for which the UE10 is attempting to register, if available.

Alternatively, the UE identity is a PLMN-specific 5G-GUTI assigned by any PLMN, if available.

Otherwise, the UE 10 includes a Subscription Concealed Identifier (SUCI) into the Registration Request message. In this case, the SUCI is an ID obtained by encrypting a Subscription Permanent Identifier (SUPI) that is an ID uniquely assigned to each UE 10.

When the UE 10 registers for a 5GS of any PLMN, it is necessary to provide the above-described Requested NSSAI to the network in a case in where the UE 10 has a Configured NSSAI or an Allowed NSSAI for this PLMN. Therefore, the UE 10 includes the Requested NSSAI into the Registration Request message, or includes mapping of respective S-NSSAIs of the Requested NSSAI and S-NSSAIs of the HPLMN into the Registration Request message. This may allow a network side to check whether to allow the S-NSSAI(s) included in the Requested NSSAI on the basis of Subscribed S-NSSAIs.

In addition, when the Default Configured NSSAI is used, the UE 10 includes Default Configured NSSAI Indication into the Registration Request message.

The UE 10 also makes it possible to support an agreement-based restriction function regarding network slices that can be registered simultaneously. In a case where the UE 10 supports this function, the UE 10 includes information indicating that this function is supported into the Registration Request message at the time of the Initial Registration and the Mobility Registration Update, as part of UE 5GMM Core Network Capability.

When providing the Configured NSSAI to a UE 10 that has notified that the UE 10 supports the agreement-based restriction function regarding the network slices that can be registered simultaneously, the AMF 301 provides information regarding a Network Slice Simultaneous Registration Group (NSSRG) related to network slices (S-NSSAI(s)) of the HPLMN.

It is necessary for the UE 10 that has received the NSSRG to only include network slices (S-NSSAIs) assigned to a common single NSSRG into the Requested NSSAI.

In a case where the UE 10 has acquired information regarding two or more NSSRGs, the UE 10 assigns relative priorities to two or more network slices (S-NSSAIs) included in the Configured NSSAI and selects information regarding an NSSRG that includes an S-NSSAI having the highest priority. The UE 10 creates Requested NSSAI that includes two or more S-NSSAIs included in the selected information regarding the NSSRG.

Here, in a case where the number of pieces of the information regarding an NSSRG that includes an S-NSSAI having the highest priority is two or more, the UE 10 selects a piece of information regarding an NSSRG that includes more S-NSSAIs having higher priorities, and creates a Requested NSSAI that includes two or more S-NSSAIs included in the selected piece of information regarding the NSSRG.

When receiving the Registration Request message from the UE 10, the (R)AN 20 executes AMF Selection (step S702). The (R)AN 20 selects the AMF 301 on the basis of a Radio Access Technology ((R)AT) and, if available, the Requested NSSAI, in a case where the Registration Request message does not include a 5G S-Temporary Mobile Subscription Identifier (5G-S-TMSI) or a Globally Unique AMF Identifier (GUAMI). Alternatively, the (R)AN 20 selects the AMF 301 on the basis of the Radio Access Technology ((R)AT) and, if available, the Requested NSSAI in a case where the 5G-S-TMSI or GUAMI included in the Registration Request message does not indicate a valid AMF 301.

In a case where the (R)AN 20 is the NG-RAN, a Registration Request is forwarded to the AMF 301 (step S703). The Registration Request includes a selected PLMN ID (for example, a PLMN corresponding to the 5GC 30 described above) or includes a pair of a Network Identifier (NID) and a PLMN ID to identify a Standalone Non-Public Network (SNPN).

In a case where the UE 10 does not provide the SUCI to the AMF 301, the AMF301 starts an Identity Request process, transmits an Identity Request message to the UE 10, and requests the SUCI (step S704).

In a case where the UE 10 receives the Identity Request message in step S704, the UE 10 transmits an Identity Response message including the SUCI (step S705). In this case, the UE 10 may acquire the SUCI by using a Public Key of the HPLMN.

The AMF 301 executes AUSF Selection on the basis of the SUPI or SUCI (step S706) and starts Authentication of the UE 10.

When the AUSF 309 receives an Authentication request from the AMF 301, it is necessary for the AUSF 309 to execute the Authentication of the UE 10.

In the Authentication process, the AUSF 309 selects the UDM 307 and acquires authentication data from the UDM 307. When the UE 10 is authenticated, the AUSF 309 provides the AMF 301 with information regarding security.

When the Authentication of UE10 succeeds, the AMF 301 starts an NG Application Protocol (NGAP) process and provides a security context to the (R)AN 20.

The (R)AN 20 holds the security context and transmits a response to the AMF 301. Thereafter, the (R)AN 20 uses the security context to protect messages exchanged with UE10.

The AMF 301 executes UDM Selection on the basis of the SUPI and selects the UDM 307 (step S707).

The AMF 301 is registered with the UDM 307 through a Nudm_UECM_Registration service (Nudm_UECM_Registration Request/Response) (steps S708 and S709).

In a case where the AMF 301 does not have Subscription Data of the UE 10, the AMF 301 uses a Nudm_SDM_Get service (Nudm_SDM_Get/Nudm_SDM_Get Response) to acquire the Subscription Data such as Access and SMF Selection Subscription data from the UDM 307 (steps S710 and S711). Here, the Subscription Data includes Slice Selection Subscription Data.

For example, in a case where slice selection is necessary because it is difficult for the AMF 301 to handle all S-NSSAIs included in the Requested NSSAI, AMF301 transmits an Nnssf_NSSelection_Get message including the Requested NSSAI, Subscribed S-NSSAI(s), the TAI, and the PLMN ID of the SUPI to the NSSF 304 (step S712). Then, The NSSF 304 executes the network slice registration determination process illustrated in FIG. 7 (step S713).

The NSSF 304 replies, to the AMF 301, an Nnssf_NSSelection_Get Response message including Allowed NSSAI, Rejected S-NSSAI(s), an AMF address list, or an AMF set (step S714).

In a case where the AMF 301 has acquired information regarding the NSSRG in step S711, the AMF 301 transmits an Nnssf_NSSelection_Get message including the information regarding the NSSRG to the NSSF 304 in step S712.

The NSSRG is restriction information indicating a group of network slices that can be registered simultaneously on the basis of the Subscription data. When an S-NSSAI is related to an NSSRG, the S-NSSAI has to be included in at least one NSSRG.

The Subscription data including information regarding the NSSRG has to include at least one default S-NSSAI. When there are one or more default S-NSSAIs, these default S-NSSAI(s) are associated with a same NSSRG. That is, the UE 10 is allowed to register all the default S-NSSAI(s) simultaneously.

The NSSF 304 selects one or more S-NSSAIs to be included into the Allowed NSSAI on the basis of the Requested NSSAI, the Subscribed S-NSSAI(s), and information regarding the NSSRG. Here, in a case where the AMF 301 has received Subscription data including the information regarding the NSSRG, the Allowed NSSAI can only include network slices (S-NSSAIs) assigned to the common single NSSRG.

In a case where the AMF 301 has acquired information regarding the priority of registration of each S-NSSAI as the supplemental information (or assistance information) of the Requested NSSAI, the AMF 301 transmits, to the NSSF 304, an Nnssf_NSSelection_Get message including information regarding the priority of registration of each S-NSSAI in step S712.

The NSSF 304 selects one or more S-NSSAIs to be included into the Allowed NSSAI on the basis of the Requested NSSAI, the Subscribed S-NSSAI(s), the information regarding the NSSRG, and the information regarding the priority of registration of each S-NSSAI.

For example, the NSSF 304 selects information regarding an NSSRG including an S-NSSAI I having the highest priority on the basis of the information regarding the priority of registration of each S-NSSAI, and creates an Allowed NSSAI that includes two or more S-NSSAIs included in the selected information regarding the NSSRG.

Here, in a case where the number of pieces of the information regarding an NSSRG that includes an S-NSSAI having the highest priority is two or more, the NSSF 304 selects a piece of information regarding an NSSRG that includes more S-NSSAIs having higher priorities, and creates Allowed NSSAI that includes two or more S-NSSAIs included in the selected piece of information regarding the NSSRG.

The AMF 301 executes NSACF Selection on the basis of instance information regarding available NSACFs that is acquired from the NRF 303 or that is locally configured in the AMF 301, and selects the NSACF 312 (step S715).

The AMF 301 uses a Nnsacf NSAC service to send an Nnsacf_SliceEventExposure_Subscribe request message to the NSACF 312 (step S716). Then, a process of registration with a Nnsacf_SliceEventExposure service is executed. When the registration gets completed, the AMF 301 receives an Nnsacf_SliceEventExposure_Subscribe response message from the NSACF 312 as a response (step S717).

Here, the Nnsacf_SliceEventExposure_Subscribe service notifies a Network Function that has registered this service, such as the AMF 301, of the number of current UEs 10 registered in the S-NSSAI (network slice) on an event basis, the number of current PDU sessions established by using the S-NSSAI, or the number of current UEs 10 that have established one or more PDU sessions by using the S-NSSAI.

The Subscribe request message of this service can include an Event ID, an Event Filter, and Event Reporting information.

An Event ID parameter defines whether to notify of the number of UEs 10 registered to the S-NSSAI, to notify of the number of PDU sessions established by using the S-NSSAI, or to notify of the number of current UEs 10 that have established one or more PDU sessions by using the S-NSSAI.

An Event Filter parameter is an S-NSSAI that is a target of the number of currently registered UEs 10 to be notified to the network function that has registered this service, an S-NSSAI that is a target of the number of currently established PDU sessions, an S-NSSAI that is a target of the number of current UEs 10 that have established one or more PDU sessions, or an S-NSSAI that is a target of a set of them.

The Event Reporting information defines whether such notification is issued on a threshold basis or periodically. In a case where the notification is issued on a threshold basis, Event Reporting is triggered when the number of current UEs 10 registered with a target S-NSSAI, the number of currently established PDU sessions, or the number of current UEs 10 that has established one or more PDU sessions reaches a threshold. In a case where the notification is issued periodically, notification is triggered when the validity period of a periodic timer expires. Here, the threshold can be set for each network slice. Optionally, it is also possible to configure a setting to perform immediate reporting.

The AMF 301 creates supplemental information regarding the S-NSSAI (step S718). Here, the supplemental information regarding the S-NSSAI is, for example, supplemental information regarding Rejected S-NSSAI created through the process illustrated in FIG. 8.

The AMF 301 transmits a Registration Accept message including supplemental information (or assistance information) regarding the S-NSSAI, Allowed NSSAI, and Rejected NSSAI to the UE 10 (step S719), and receives a Registration Complete message from the UE 10 as a response (step S720).

In addition, in a case where there is no S-NSSAI that can be included into the Allowed NSSAI and registration is rejected, the AMF 301 may set an RFSP index for guidance to the Area of Service (AoS) or Tracking Area (mobility management area) of the VPLMN that supports the Rejected S-NSSAI and Target NSSAI including the Rejected S-NSSAI, and may transmit the Target NSSAI and the RFSP index for the Target NSSAI to the (R)AN 20. At this time, the AMF 301 may request the (R)AN 20 to create a radio resource management policy corresponding to the RFSP index. The radio resource management policy is, for example, to assign higher priority to VPLMN cell operation frequency than HPLMN cell operation frequency in a cell selection/reselection process.

In accordance with the radio resource management policy corresponding to the RFSP index, the (R)AN 20 sets priorities on measurement frequencies in the cell selection/reselection process with regard to the UE 10.

The UE 10 makes it possible to execute the cell selection/reselection process in accordance with the set priorities of the measurement frequencies, and to detect a VPLMN cell. Next, the UE 10 makes it possible to request registration including the Rejected S-NSSAI as the Requested NSSAI from the VPLMN cell. Here, the UE 10 makes it possible to acquire information regarding mapping of Rejected S-NSSAI of HPLMN and S-NSSAI of VPLMN from the AMF 301, and include the S-NSSAI of the VPLMN corresponding to the Rejected S-NSSAI into in the registration request as Requested NSSAI.

### 6.4 Check on Camping on Area of Service (AoS) of Network Slice

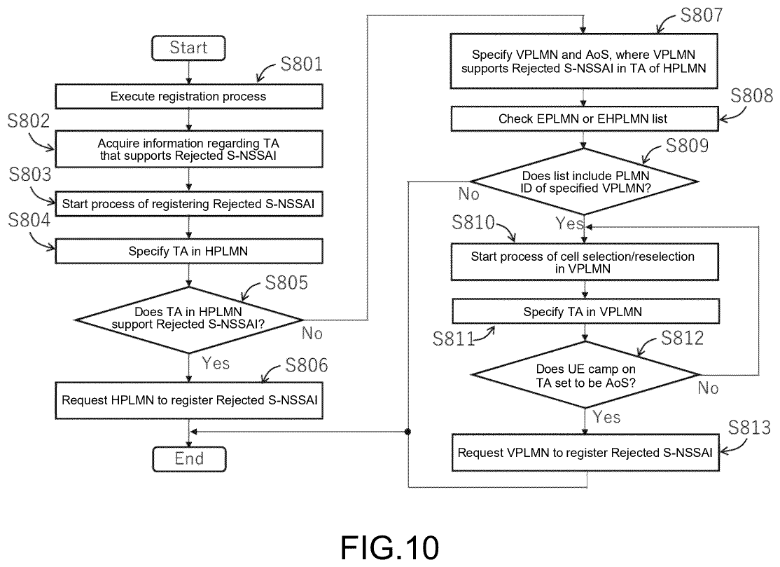

FIG. 10 is a diagram illustrating an example a procedure of checking availability of a network slice with regard to the UE 10.

When the UE 10 executes a registration process (step S801), the UE 10 acquires information on a Tracking Area that supports Rejected S-NSSAI in addition to Allowed NSSAI during the registration process (step S802). Conventionally, a request for registration of the Rejected S-NSSAI again in the Registration Area is not allowed. However, only in a case where the information regarding the Tracking Area that supports the Rejected S-NSSAI has been acquired, the request for registration in the Tracking Area that supports Rejected S-NSSAI is allowed.

Here, the information regarding the Tracking Area that supports the Rejected S-NSSAI is, for example, the supplemental information (or assistance information) regarding the Rejected S-NSSAI created through the process illustrated in FIG. 8.

When a process for utilizing the Rejected S-NSSAI starts, the UE 10 starts the process of registering the Rejected S-NSSAI (step S803).

The UE 10 executes a cell selection/reselection process with regard to a cell belonging to the HPLMN, and specifies a Tracking Area of the HPLMN to which the selected cell belongs (step S804). At this time, in addition to or instead of the cell selection/reselection process with regard to the HPLMN, the UE 10 may identify a synchronization signal block (SSB: Synchronization Signal/PBCH Block) to specify a beam.

The synchronization signal block includes a Primary Synchronization Signal (PSS), a Secondary Synchronization Signal (SSS), and a Physical Broadcast Channel (PBCH), and the UE 10 receives the PSS and SSS of the synchronization signal blocks for cell search.

The UE 10 receives the PBCH of the synchronization signal block and acquires a Master Information Block (MIB) that is system information. The MIB includes parameters, such as a Control Resource Set (CORESET) #0. These parameters are for monitoring a Physical Downlink Control CHannel (PDCCH) that schedules a Physical Downlink Shared CHannel (PDSCH) that conveys a System Information Block 1 (SIB1 ) serving as the system information.

The base station device transmits different synchronization signal blocks by using different antenna directivities, and the UE 10 identifies the received synchronization signal block. This allows the UE 10 to specify one of the antenna directivities transmitted from the base station device. Here, the different antenna directivities are controlled by amplitudes and phases of signals fed to a plurality of antenna elements, and are also referred to as beams.

Next, on the basis of the information regarding the Tracking Area that supports the Rejected S-NSSAI, it is checked whether Rejected S-NSSAI is supported in the specified Tracking Area of the HPLMN (step S805). When the Rejected S-NSSAI is supported in the Tracking Area of the HPLMN, the UE 10 requests the HPLMN to register the Rejected S-NSSAI (step S806), and ends the process.

When the Rejected S-NSSAI (for example, S-NSSAI-H2) is not supported in the Tracking Area (for example, HPLMN_TA2) of the HPLMN, a PLMN ID of the VPLMN and an AoS, where the VPLMN supports the Rejected S-NSSAI in the Tracking Area of the HPLMN are specified on the basis of the information regarding the Tracking Area that supports the Rejected S-NSSAI (step S807). Here, the AoS is, for example, a region where the HPLMN_TA2 and the VPLMN_TA1 overlap with each other.

The UE10 checks the EPLMN list or the EHPLMN list (step S808). It is checked whether the EPLMN list or the EHPLMN list includes the PLMN ID of the VPLMN specified in the step S807 (step S809). When included, the cell selection/reselection process starts with regard to a cell belonging to the VPLMN (step S810). Here, the cell selection/reselection process with regard to the cell belonging to the VPLMN is set to be executed at a timing different from a timing of the cell selection/reselection process with regard to the cell belonging to the HPLMN executed in step S804.

The UE 10 executes a cell selection/reselection process with regard to a cell belonging to the VPLMN, and specifies a Tracking Area of the VPLMN to which the selected cell belongs (step S811). At this time, in addition to or instead of the cell selection/reselection process with regard to the VPLMN, the UE 10 may identify a synchronization signal block to specify a beam.

The UE 10 checks whether it camps on the Tracking Area of the VPLMN that is set to be the Aos specified in the step S807 (step S812) £ When it camps on the Tracking Area, the VPLMN is requested to register the Rejected S-NSSAI (step S813), and the process ends.

In a case where the Aos is set at a granularity of the Tracking Area, it is checked whether it camps on the AoS by using information regarding the Tracking Area including the cell selected through the cell selection/reselection process with regard to the cell belonging to the VPLMN.

In a case where the Aos is set at a granularity of the cell ID, it is checked whether it camps on the AoS by using information regarding the ID of the cell selected through the cell selection/reselection process with regard to the cell belonging to the VPLMN.

In a case where the Aos is set as a region using coordinates such as latitude and longitude, it is checked whether it camps on the Aos by using location information detected by the UE10. The location information regarding the UE10 is detected, for example, through the method described in [5. Location Information Management Function].

Here, the Rejected S-NSSAI (for example, S-NSSAI-V2) with regard to the VPLMN that is the serving PLMN is specified as S-NSSAI of the VPLMN corresponding to the S-NSSAI-H2 serving as the Rejected S-NSSAI of the HPLMN, on the basis of information regarding mapping.

In addition, in the step S809, the process ends when the EPLMN list or EHPLMN list does not include the PLMN ID of the VPLMN specified in the step S807.

Also, the cell selection/reselection process in the step S810 is executed at set intervals with regard to a cell belonging to the VPLMN, when the UE 10 does not camp on the Tracking Area of the VPLMN set to be the Aos in step S812.

As described above, with regard to the Tracking Area of the HPLMN that does not support a specific network slice, the UE 10 is provided with information regarding an AoS and VPLMN that support the network slice within the Tracking Area among VPLMNs included in the EPLMN list or the EHPLMN list serving as roaming candidates. This allows the UE 10 to use the network slice in the AoS of the VPLMN that is at least a part of a region in the Tracking Area of the HPLMN where network slices could not be used in past. In other words, it is possible to improve availability of network slices for the UE 10.

In addition, with regard to a Tracking Area of the HPLMN that restricts registration of a specific network slice under the admission control, the UE 10 is provided with information regarding an AoS and VPLMN that support the network slice within the Tracking Area among VPLMNs included in the EPLMN list or the EHPLMN list serving as roaming candidates. This allows the UE 10 to use the network slice in the AoS of the VPLMN that is at least a part of a region in the Tracking Area of the HPLMN where network slices could not be used in past.

Furthermore, a unit of region that does not support a specific network slice and a unit of region that restricts registration of a specific network slice under the admission control or on the basis of the subscription data are not limited to the Tracking Area (mobility management area). The Registration Area or the Area of Service (AoS) may be used as the unit of such region. Here, the Aos is, for example, a region defined by a coordinate system such as latitude and longitude, a cell ID, a set of cell IDs, a base station ID, or a set of base station IDs to define a region at a finer granularity than the Tracking Area.

### 7. Second Method of Improving Availability of Network Slice

FIG. 6 illustrates the example in which the VPLMN that supports a specific network slice is available in the Tracking Area of the HPLMN that does not support the specific network slice. However, instead of the VPLMN, it is also possible to use a Stand-alone Non-Public Network (SNPN) such as local 5G. Note that, unlike the VPLMN, it is assumed that an SNPN operator does not have the SLA with the HPLMN for roaming. Therefore, an additional procedure is necessary to improve the availability of the network slice by using the SNPN instead of the VPLMN. Note that, in a case where the SNPN operator has the SLA with the HPLMN for roaming, the process illustrated in FIG. 10 can be used as in a way similar to the case of the VPLMN.

### Candidate SNPN Detection Process

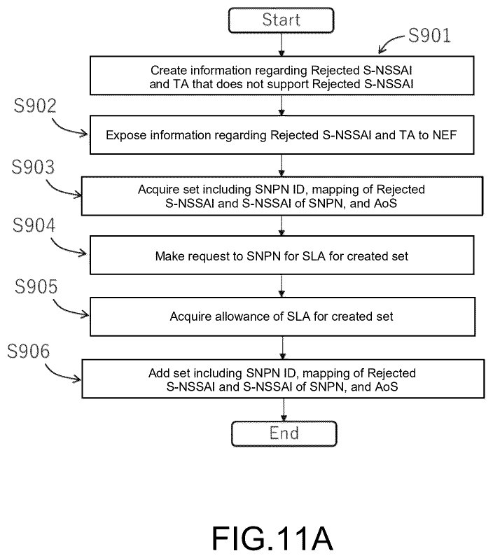

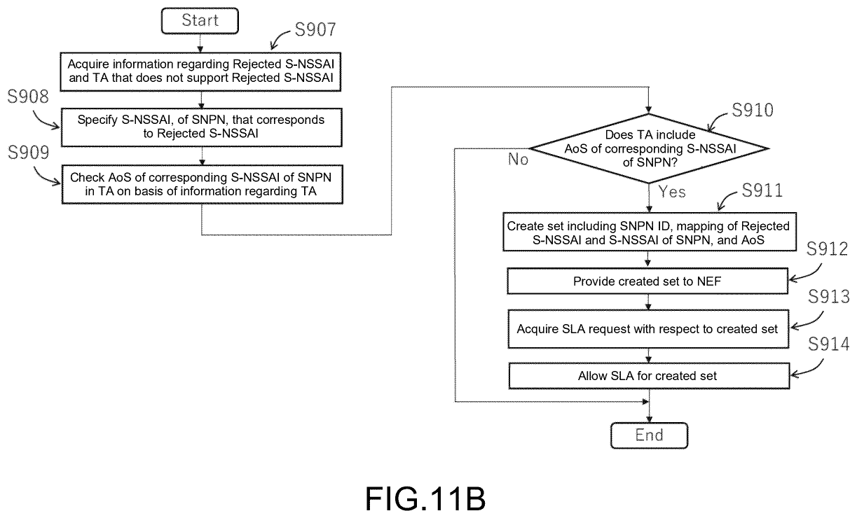

FIG. 11A is a diagram illustrating an example of a process performed by the HPLMN side with regard to candidate SNPN detection.

When a candidate SNPN detection process starts, the 5GC 30 (for example, AMF 301) of the HPLMN creates information regarding the Rejected S-NSSAI (for example, S-NSSAI-H2) and a Tracking Area (for example, HPLMN_TA2) that does not support the Rejected S-NSSAI (step S901). Here, since the HPLMN does not have the SLA with the SNPN for roaming, the HPLMN does not possess information regarding mapping of each S-NSSAI supported by the SNPN and corresponding S-NSSAI of the HPLMN.

The 5GC 30 of the HPLMN exposes a request including the Rejected S-NSSAI and information regarding the Tracking Area that does not support the Rejected S-NSSAI via the NEF 302 (step S902). The information regarding the Rejected S-NSSAI is, for example, the number of QoS flows supported for the Rejected S-NSSAI, and characteristics of the respective QoS flows. Here, the characteristics of the QoS flows may be, for example, the 5QI, or a set of information regarding resource type, priority, packet delay tolerance, packet error rate, averaging window, maximum data burst volume, and the like.

In addition, the information related to the Rejected S-NSSAI may include information indicating whether to use a specific function of the 5GC 30, such as whether to use an Edge Application Server (EAS) with regard to the Rejected S-NSSAI, whether to use an Artificial Intelligence (AI)/Machine Learning (ML) model, and whether to use a Network Data Analytics Function (NWDAF).

The Network Data Analytics Function can include an Analytics Logical Function (AnLF) that uses a trained AI/ML model to execute inference and create analytical information, and a Model Training Logical Function (MTLF) that trains the AI/ML model.

The Network Data Analytics Function uses various sensing information acquired from the UE 10 and the AI/ML models acquired depending on applications to perform, for example, image recognition, voice recognition, automatic translation, estimation of two-dimensional or three-dimensional location, estimation of time for synchronization, calculation of assist information to support autonomous driving or Advanced Driver-Assistance Systems (ADAS), creation of layers of quasi-static information, layers of quasi-dynamic information, and/or layers of dynamic information that constitute a dynamic map, and the like.

The NEF 302 of the 5GC 30 manages at least two access levels for with regard to the SNPN. The two access levels include a first access level that can be accessed only by SNPNs that have the SLA with the HPLMN, and a second access level that can be accessed only by SNPNs that do not have the SLA with the HPLMN.

In step S902, the 5GC 30 of the HPLMN exposes information regarding the Rejected S-NSSAI and the Tracking Area that does not support the Rejected S-NSSAI at the second access level. In other words, an SNPN that does not have the SLA with the HPLMN makes it possible to acquire the information regarding the Rejected S-NSSAI and the Tracking Area that does not support the Rejected S-NSSAI via the NEF 302 of the 5GC 30.

Via the NEF 302, the 5GC 30 of the HPLMN acquires a set of the following (step S903):
An SNPN ID of an SNPN in a target Tracking Area;
Mapping between Rejected S-NSSAI and S-NSSAI of the SNPN; and
An AoS.
   In a case where utilization of an SNPN service corresponding to the created set is requested, a message of requesting the SLA for the created set is transmitted to the SNPN (step S904).

Via the NEF 302, the 5GC 30 of the HPLMN acquires allowance of the SLA for the created set, from the SNPN that has received the request (step S905).

When the allowance of the SLA for the created set is acquired from the SNPN, the HPLMN makes it possible to use the process illustrated in FIG. 10 in a way similar to the above-described case of the VPLMN with regard to utilization of the Rejected S-NSSAI included in the set.

The 5GC 30 of the HPLMN adds the set of the SNPN ID, the mapping of the Rejected S-NSSAI and the S-NSSAI of the SNPN, and the Aos, to the supplemental information (or assistance information) regarding the Rejected S-NSSAI (step S906).

Furthermore, the 5GC 30 of the HPLMN may instruct to add the SNPN ID to the EPLMN list or the EHPLMN list of the UE 10 to allow the UE 10 to treat an SNPN corresponding to the SNPN ID as a roaming candidate.

FIG. 11B is a diagram illustrating an example of a process performed by the SNPN side with regard to candidate SNPN detection.

The SNPN acquires information regarding the Rejected S-NSSAI and the Tracking Area that does not support the Rejected S-NSSAI via the NEF 302 (step S907). It is possible for the SNPN to acquire the information via the NEF 302 at any timing or at desired timing. For example, information for providing a service may be acquired in a case where there is a frequency band or radio resource unused by the SNPN and the unused frequency band or radio resource can be used (for example, borrowed) by the 5GC 30 of the HPLMN.

The SNPN specifies the corresponding S-NSSAI (for example, S-NSSAI-S2) of the SNPN on the basis of the information regarding the Rejected S-NSSAI acquired from the HPLMN (step S908). In a case where there is no corresponding S-NSSAI, the SNPN may configure the corresponding S-NSSAI on the basis of the information regarding the Rejected S-NSSAI (for example, the number of supported QoS flows, characteristics of the respective QoS flows).

On the basis of the information regarding the Tracking Area that does not support the Rejected S-NSSAI acquired from the HPLMN, the SNPN checks the AoS of the corresponding S-NSSAI of the SNPN specified in the step S908 within a target Tracking Area (step S909). Here, the AoS of the S-NSSAI of the SNPN is, for example, the SNPN ID corresponding to the network belonging to the SNPN, the Tracking Area of the SNPN, or a cell ID of a base station belonging to the SNPN.

The SNPN ID used for identifying the SNPN is an identifier obtained by combining the PLMN ID and the Network IDentifier (NID). Here, it is sufficient for the PLMN ID used for the SNPN ID to be a locally unique ID (for example, ID that is unique in the SNPN) unlike the PLMN ID that is a Globally Unique IDentifier (GUID) used in a Public Network Integrated NPN (PNI-NPN).

Next, it is checked whether the target Tracking Area includes the AoS of the corresponding S-NSSAI of the SNPN (step S910). When not included, the process ends.

Here, the information regarding the Tracking Area is, for example, information regarding a region defined by latitude, longitude, and distance. For example, such a region is a circular region set on the basis of latitude and longitude of coordinates indicating its center and a distance of its radius, or a polygonal region set on the basis of latitude and longitude of coordinates of respective corners.

When the target Tracking Area includes the AoS of the corresponding S-NSSAI of the SNPN, the SNPN creates a set of the following (step S911):
SNPN ID;
Mapping between Rejected S-NSSAI and S-NSSAI of the SNPN; and
An AoS.
   Next, the SNPN provides the created set to the NEF 302 (step S912).

The SNPN acquires an SLA request message with regard to the created set, from the 5GC30 of the HPLMN via the NEF 302 (step S913).

When the SLA request with regard to the created set is allowed, the SNPN replies an SLA Accept message with regard to the created set (step S914) and ends the process.

Furthermore, a validity period may be set for the SLA allowance with regard to the created set in the step S914. In other words, the UE 10 belonging to the HPLMN makes it possible to use services corresponding to the set created by the SNPN only within the validity period. Therefore, the information regarding the Tracking Area supporting the Rejected S-NSSAI or the information added to the supplemental information (SNPN ID of SNPN, information regarding mapping of a value of Rejected S-NSSAI in HPLMN and a corresponding value of S-NSSAI used in SNPN, and information regarding AoS) is deleted when the validity period expires. In a similar way, the SNPN ID added to the EPLMN list or the EHPLMN list of the UE 10 is also deleted when the validity period expires.

As described above, the 5GC 30 of the HPLMN exposes information regarding the Rejected S-NSSAI and the Tracking Area that does not support the Rejected S-NSSAI via the NEF 302, acquires information regarding the Aos that makes it possible to support the Rejected S-NSSAI and the correspondence relation between the target network slice in the HPLMN and the target network slice in the SNPN from the SNPN, concludes a dynamic/on-demand SLA with the SNPN, and thereby makes it possible to treat the SNPN equally with the VPLMN described above. In other words, the availability of the network slices can be further improved.

Furthermore, a unit of region that does not support a specific network slice is not limited to the Tracking Area (mobility management area). The Registration Area or the Area of Service (AoS) may be used as the unit of such region. Here, the AoS is, for example, a region defined by a coordinate system such as latitude and longitude, a cell ID, a set of cell IDs, a base station ID, or a set of base station IDs to define a region at a finer granularity than the Tracking Area.

### 8. Third Method of Improving Availability of Network Slice

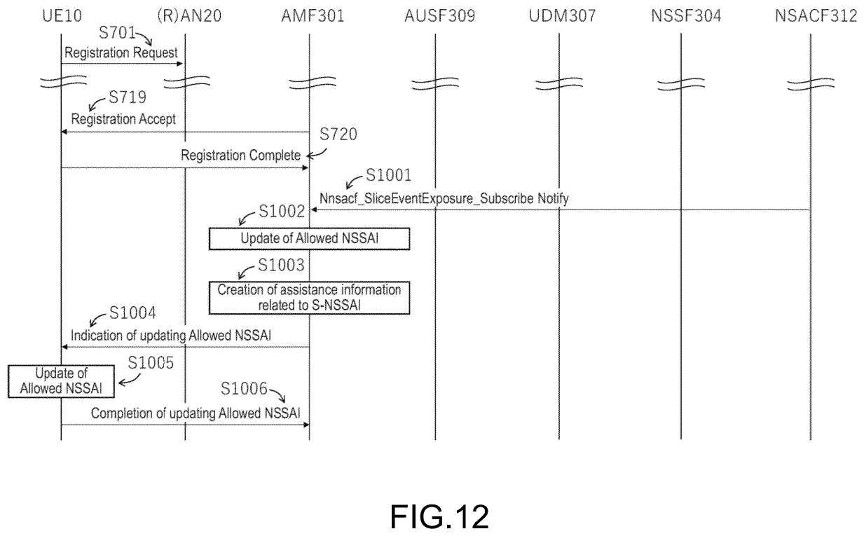

FIG. 12 is a diagram illustrating an example of a process of updating registration information associated with the admission control.

After executing the registration process illustrated in FIG. 9A and FIG. 9B, the UE 10 receives a Registration Accept message including supplemental information (or assistance information) regarding the S-NSSAI, Allowed NSSAI, and Rejected NSSAI from the AMF 301 (step S719), and replies a Registration Complete message to the AMF 301 as a response (step S720).

Through the Nnsacf SliceEventExposure Subscribe service registered in the step S716, the AMF 301 receives an Nnsacf_SliceEventExposure_Subscribe Notify message including a status of the network slice depending on an event from the NSAC F312 (step S1001). Here, the status of the network slice includes, for example, at least one of the number of UEs 10 registered with a target network slice, the number of established PDU sessions, the number of UEs 10 that have established one or more PDU sessions, a notification that the number of registered UEs 10 has exceeded a threshold, a notification that the number of established PDU sessions has exceeded a threshold, a notification that the number of UEs 10 that have established one or more PDU sessions has exceeded a threshold, or the like.

The AMF 301 updates the Allowed NSSAI to perform the admission control in response to the notification from the NSACF 312 (step S1002). Here, a criterion for starting the admission control may be set in the AMF 301 for each network slice. The criteria may include the number of registered UEs 10, the number of established PDU sessions, and the number of UEs 10 that have established one or more PDU sessions. Under the admission control, the AMF 301 makes it possible to decide whether to set a validity period for the S-NSSAI (network slice) registered as the Allowed NSSAI or to delete the target S-NSSAI from the Allowed NSSAI, and notify the UE 10 of such an instruction as supplemental information (or assistance information) regarding the S-NSSAI.

Here, it is possible to decide whether to set the validity period for a target S-NSSAI (network slice) included in the Allowed NSSAI or to delete the target S-NSSAI from the Allowed NSSAI, on the basis of the priority of registration of each S-NSSAI included in the supplemental information (or assistance information) of the Requested NSSAI.

It is also possible to decide whether to set the validity period for a target S-NSSAI included in the Allowed NSSAI or to delete the target S-NSSAI from the Allowed NSSAI, on the basis of a notification from the NSACF 312. For example, in a case where the number of currently established PDU sessions has not reached a maximum number but the number of currently registered UEs 10 has reached a maximum number, it is determined that the number of UEs 10 registered with the target S-NSSAI is large but the number of UEs 10 using the target S-NSSAI is small, and it is decided to set the validity period for registration of the target S-NSSAI.

Furthermore, as supplemental information regarding the S-NSSAI, the AMF 301 may decide conditions for reregistration of S-NSSAI that has been registered as Allowed NSSAI under the admission control.

For example, in a case of deleting the target S-NSSAI from the Allowed NSSAI, the AMF 301 decides the conditions for reregistration of the target S-NSSAI as the supplemental information regarding the S-NSSAI. Alternatively, the AMF 301 decides the conditions for reregistration of the target S-NSSAI in a case of deleting the target S-NSSAI from the Allowed NSSAI after the validity period set for the target S-NSSAI included in the Allowed NSSAI expires.

Here, the conditions for reregistration of the target S-NSSAI include, for example, a condition that a request for reregistration is prohibited in a same Registration Area or a same Tracking Area, a condition that a backoff timer is set until reregistration in the same Registration Area or the same Tracking Area, or other conditions.

In a case where a request for re-registration is prohibited in a same Registration Area, in a same Tracking Area, or in a same Area of Service (AoS), the AMF 301 creates information regarding an AoS and VPLMN supporting the target S-NSSAI in the same Registration Area, the same Tracking Area, or the same AoS as the supplemental information regarding the S-NSSAI. In addition, in a case where a request for re-registration is prohibited in a same Registration Area, in a same Tracking Area (mobility management area), or in a same AoS, the AMF 301 may create information regarding an AoS and VPLMN supporting the target S-NSSAI in the same Registration Area, the same Tracking Area (mobility management area), or the same AoS as the supplemental information regarding the S-NSSAI.

As described above, the AMF 301 creates supplemental information regarding the S-NSSAI (step S1003). The supplemental information includes the setting of the validity period of the S-NSSAI registered as the Allowed NSSAI, an instruction to delete the target S-NSSAI from the Allowed NSSAI, the conditions for reregistration of the target S-NSSAI, the information regarding the AoS and VPLMN supporting the target S-NSSAI in the Registration Area, Tracking Area, or AoS where request for reregistration is prohibited, information regarding the SNPN and AoS, and the like.

The AMF 301 transmits an instruction to the UE 10 to update Allowed NSSAI including the supplemental information regarding the S-NSSAI, in addition to or instead of the updated Allowed NSSAI (step S1004). Here, the instruction to update the Allowed NSSAI may be an instruction to replace the Allowed NSSAI possessed by the UE 10 with the updated Allowed NSSAI, or an instruction to delete the target S-NSSAI from the Allowed NSSAI.

When receiving the updated Allowed NSSAI and/or the supplemental information regarding the S-NSSAI from the AMF 301, the UE 10 performs a necessary process (step S1005).

In a case of receiving the updated Allowed NSSAI, the UE 10 updates the Allowed NSSAI possessed by the UE 10 with the newly received Allowed NSSAI.

In a case of receiving the supplemental information regarding the S-NSSAI, the UE 10 configure necessary settings in accordance with the supplemental information.

For example, in a case where the supplemental information regarding the S-NSSAI includes an instruction to delete the target S-NSSAI from the Allowed NSSAI, the UE 10 deletes the target S-NSSAI from the Allowed NSSAI.

In a case where the supplemental information regarding the S-NSSAI includes an instruction to set a validity period for the S-NSSAI included in the Allowed NSSAI, the UE 10 starts a timer for which the validity period is set.

In a case where the supplementary information regarding the S-NSSAI includes the conditions for reregistration of the S-NSSAI registered as the Allowed NSSAI, the UE 10 sets the conditions for reregistration of the target S-NSSAI when deleting the target S-NSSAI from the Allowed NSSAI.

For example, in a case where the condition for reregistration is a condition that a request for reregistration is prohibited in a same Registration Area, a same Tracking Area, or a same AoS, the UE 10 sets the target S-NSSAI as the Rejected S-NSSAI or adds it to a set of Rejected NSSAIS.

In a case where the condition for reregistration is a condition that a backoff timer is set until reregistration in the same Registration Area, the same Tracking Area, or the same AoS, the UE 10 starts a timer for which the backoff period of the target S-NSSAI is set.

The UE 10 sets the target S-NSSAI as Pending S-NSSAI or adds it to a set of Pending NSSAIs during the backoff period.

When the timer for which the backoff period is set expires, this allows the UE 10 to request reregistration in the same Registration Area, the same Tracking Area, or the same AoS.

When the necessary settings are completed, the UE 10 replies, to the AMF 301, a response indicating that update of the Allowed NSSAI is completed (step S1006).

Next, in a case where the supplemental information regarding the S-NSSAI includes information regarding an AoS and VPLMN supporting the target S-NSSAI in the Registration Area, Tracking Area, or AoS where request for reregistration is prohibited, the UE 10 confirms that the UE 10 camps on the Registration Area, Tracking Area, or AoS where request for reregistration prohibited and also camps on an AoS of a VPLMN supporting the target S-NSSAI, and then requests the VPLMN to register the S-NSSAI of the VPLMN corresponding to the target S-NSSAI.

Also, in a case where the supplemental information regarding the S-NSSAI includes information regarding an AoS and SNPN supporting the target S-NSSAI in the Registration Area or Tracking Area where request for reregistration is prohibited, the UE 10 confirms that the UE 10 camps on the Registration Area, Tracking Area, or AoS where request for reregistration prohibited and also camps on an AoS of the SNPN supporting the target S-NSSAI, and then requests the SNPN to register the S-NSSAI of the SNPN corresponding to the target S-NSSAI.

As described above, at the time of admission control based on dynamic network slice statuses managed by the NSACF 312, there is a concern that usage of a specific network slice may be restricted in a specific Registration Area, a specific Tracking Area (mobility management area), or a specific AoS. However, it is possible to improve availability of the network slice by providing the UE 10 with information for complementing it with a network slice provided by at least one of the VPLMN or SNPN through the roaming within the restricted Registration Area, Tracking Area, or AoS.

Note that, the dynamic network slice status may be acquired by using not only the Nnsacf_SliceEventExposure_Subscribe service through subscription/notification, but also an Nnsacf_NSAC_NumOfUEsUpdate service, Nnsacf_NSAC_NumOfPDUsUpdate service, or Nnsacf_NSAC_EACNotify service serving as an Nnsacf_NSAC services through on-demand request/response.

The Nnsacf_NSAC_NumOfUEsUpdate service replies a notification indicating whether the number of UEs 10 registered in each target S-NSSAI has reached a maximum number, in response to a request including at least one or more S-NSSAIs (network slices) that are check targets. Also, the Nnsacf_NSAC_NumOfUEsUpdate service may reply a notification indicating whether the number of UEs 10 that have established one or more PDU sessions using each target S-NSSAI has reached a maximum number, in response to the request including at least one or more S-NSSAIs (network slices) that are check targets. Here, it is determined whether to reply the notification indicating whether the number of UEs 10 registered in each S-NSSAI has reached a maximum number, to reply the notification indicating whether the number of UEs 10 that have established one or more PDU sessions using each S-NSSAI has reached a maximum number, or to reply the both notifications, on the basis of an instruction included in the request. In other words, the request can include information indicating a question asking Whether the number of UEs 10 registered in each S-NSSAI has reached a maximum number, a question asking whether the number of UEs 10 that have established one or more PDU sessions using each S-NSSAI has reached the maximum number, or the both questions. Also, a service other than the Nnsacf_NSAC_NumOfUEsUpdate service such as Nnsacf_NSAC_NumOfUEsw/PDUsUpdate may be defined as a service that replies a notification indicating whether the number of UEs 10 that have established one or more PDU sessions using each target S-NSSAI has reached a maximum number in response to the request including one or more S-NSSAIs (network slices) that are check targets.

The Nnsacf_NSAC_NumOfPDUsUpdate service replies a notification indicating whether the number of PDU sessions established by using each target S-NSSAI has reached a maximum number, in response to a request including at least one S-NSSAI that is a check target.

The Nnsacf_NSAC_EACNotify service makes it possible to activate or deactivate an Early Availability Check (EAC) mode with regard to the NSACF 312 in accordance with a request including at least one or more target S-NSSAIs.

When the number of UEs 10 registered in the S-NSSAI serving as the check target exceeds a first threshold (for example, a value corresponding to 75% of the maximum number of UEs 10 allowed to be registered) set by an operator (PLMN), the EAC replies a notification indicating that the EAC mode is activated. When the number of UEs 10 registered in the S-NSSAI serving as the check target falls below a second threshold set by the operator, the EAC replies a notification indicating that the EAC mode is deactivated. Here, the first threshold may be a same value as the second threshold, or may be a different value from the second threshold.

Note that, when the number of UEs 10 that have established one or more PDU sessions using the S-NSSAI serving as the check target exceeds the first threshold set by the operator (PLMN), the EAC may reply a notification indicating that the EAC mode is activated. When the number of UEs 10 that have established one or more PDU sessions using the S-NSSAI serving as the check target falls below the second threshold set by the operator, the EAC may reply a notification indicating that the EAC mode is deactivated. When requesting or subscribing to the Nnsacf_NSAC_EACNotify service, the AMF 301 sets the number of UEs 10 registered in the S-NSSAI or the number of UEs 10 that have established one or more PDU sessions using the S-NSSAI as the check target. Alternatively, the AMF 301 may set both the number of UEs 10 registered in the S-NSSAI and the number of UEs 10 that have established one or more PDU sessions using the S-NSSAI as the check targets. In this case, the NSACF 312 also replies information indicating which criterion is used for activating/deactivating the EAC mode. The criterion includes the number of UEs 10 registered in the S-NSSAI and the number of UEs 10 that have established one or more PDU sessions using the S-NSSAI.

As described above, by managing the number of UEs 10 registered in the network slice (S-NSSAI), the number of PDU sessions established using the network slice (S-NSSAI), and/or the number of UEs 10 that have established one or more PDU sessions using the network slice (S-NSSAI) and performing the admission control on a network slice provided by the HPLMN, it is possible for the HPLMN to ensure isolation between the network slices and provide the services of the respective network slice with stable qualities. In addition, it is also possible to improve network slice use efficiency by performing control in such a manner that deviation of the number of UEs 10 registered in each network slice from the number of UEs 10 that actually use the network slice (that is, the number of UEs 10 that have established PDU sessions using the network slice) decreases. Furthermore, it is also possible to improve availability of the network slices while effectively utilizing HPLMN resources, by providing information regarding the VPLMN and/or the local network (SNPN) and the Aos that supports the target network slice in the Registration Area, Tracking Area (mobility management area), or Aos whose usages are restricted under the admission control.

In addition, in the step S1003, the AMF 301 may include information that is acquired from the NSACF 312 and that indicates the number of UEs 10 registered in the network slice (S-NSSAI), the number of PDU sessions established using the network slice (S-NSSAI), and/or the number of UEs 10 that have established one or more PDU sessions using the network slice (S-NSSAI), into the supplemental information regarding the S-NSSAI as information regarding the admission control. In step S1004, the UE 10 makes it possible to acquire, via the AMF 301, the information regarding the admission control such as the number of UEs 10 registered for each network slice (S-NSSAI), the number of established PDU sessions, and/or the number of UEs 10 that have established one or more PDU sessions.

The UE 10 selects one network slice (S-NSSAI) to establish a PDU session from among Allowed NSSAIs on the basis of the acquired information regarding the admission control. For example, the UE 10 selects a network slice (S-NSSAI) including a small number of registered UEs 10 from among a plurality of candidates that supports an application. Alternatively, the UE 10 selects a network slice (S-NSSAI) including a small number of established PDU sessions from among the plurality of candidates that supports the application. Alternatively, the UE 10 selects a network slice (S-NSSAI) including a small number of UEs 10 that have established one or more PDU sessions from among the plurality of candidates that supports the application.

The above-described process performed on the UE10 achieves equalization with regard to usage of network slices, and this makes it possible to reduce risk that the network slices are unavailable due to the admission control. In other words, availability of the network slices can be improved.

### 8. Fourth Method of Improving Availability of Network Slice

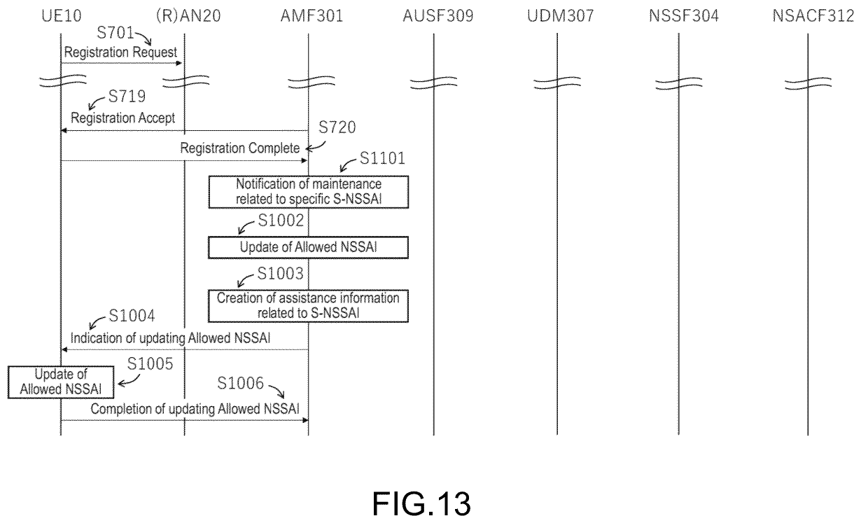

FIG. 13 is a diagram illustrating an example of a process of updating registration information associated with network maintenance management. In this update process, for example, operation of a specific network slice is stopped for network maintenance management. In FIG. 13, steps that perform processes similar to FIG. 12 are denoted by the same reference signs as FIG. 12.

After executing the registration process illustrated in FIG. 9A and FIG. 9B, the UE 10 receives a Registration Accept message including supplemental information regarding the S-NSSAI, Allowed NSSAI, and Rejected NSSAI from the AMF 301 (step S719), and replies a Registration Complete message to the AMF 301 as a response (step S720).

For example, the AMF 301 acquires a notification regarding the network maintenance management from Operations, Administration and Maintenance (OAM) (not illustrated) (step S1101). The notification regarding the network maintenance management is a notification of stop of operation in a specific Registration Area, a specific Tracking Area (mobility management area), or a specific AoS (Area of Service) such as the HPLMN_TA4 (tracking area), with regard to a specific network slice (S-NSSAI such as the S-NSSAI-H2.

The AMF 301 updates the Allowed NSSAI in accordance with the notification regarding maintenance management (step S1002). For example, the AMF 301 deletes a network slice (for example, S-NSSAI-H2) whose operation will be stopped from the Allowed NSSAI.

The AMF 301 creates supplemental information regarding the S-NSSAI (step S1003). The supplemental information includes an instruction to delete the target S-NSSAI (for example, S-NSSAI-H2) from the Allowed NSSAI, information regarding the AoS and VPLMN that support the S-NSSAI-H2 in the HPLMN_TA4 that does not support the S-NSSAI-H2, information regarding the SNPN and AoS, and/or the like.

The AMF 301 transmits an instruction to the UE 10 to update Allowed NSSAI including the supplemental information (assistance information) regarding the S-NSSAI, in addition to or instead of the updated Allowed NSSAI (step S1004). Here, the instruction to update the Allowed NSSAI may be an instruction to replace the Allowed NSSAI possessed by the UE 10 with the updated Allowed NSSAI, or an instruction to delete a specific network slice (for example, S-NSSAI-H2) from the Allowed NSSAI.

When receiving the updated Allowed NSSAI and/or the supplemental information regarding the S-NSSAI from the AMF 301, the UE 10 performs a necessary process (step S1005).

In a case of receiving the updated Allowed NSSAI, the UE 10 updates the Allowed NSSAI possessed by the UE 10 with the newly received Allowed NSSAI.

In a case of receiving the supplemental information regarding the S-NSSAI, the UE 10 configure necessary settings in accordance with the supplemental information.

For example, in a case where the supplemental information regarding the S-NSSAI includes an instruction to delete the target S-NSSAI from the Allowed NSSAI, the UE 10 deletes the target S-NSSAI from the Allowed NSSAI.

When the necessary settings are completed, the UE 10 replies, to the AMF 301, a response indicating that update of the Allowed NSSAI is completed (step S1006).

Next, in a case where the supplemental information regarding the S-NSSAI includes information regarding an AoS and VPLMN supporting the target S-NSSAI in a specific Registration Area, a specific Tracking Area, or a specific AoS that does not support a specific network slice, the UE 10 confirms that the UE 10 camps on the specific Registration Area, specific Tracking Area, or specific AoS and also camps on an AoS of a VPLMN supporting the target S-NSSAI, and then requests the VPLMN to register the S-NSSAI of the VPLMN corresponding to the target S-NSSAI.

Next, in a case where the supplemental information regarding the S-NSSAI includes information regarding an SNPN and an AoS of the SNPN supporting the target S-NSSAI in the specific Registration Area, specific Tracking Area, or specific AoS that does not support the specific network slice, the UE 10 confirms that the UE 10 camps on the specific Registration Area, specific Tracking Area, or specific AoS and also camps on the AoS of the SNPN supporting the target S-NSSAI, and then requests the SNPN to register the S-NSSAI of the SNPN corresponding to the target S-NSSAI.

In addition, the notification regarding network maintenance management acquired in the step S1101 may include information regarding time to stop operation or a period until operation is stopped with regard to the network slice (S-NSSAI) whose operation will be stopped.

When receiving the notification regarding network maintenance management, the UE 10 decides the validity period of the target S-NSSAI on the basis of the time to stop operation or the period until operation is stopped, and starts a timer for which the validity period is set.

To avoid instantaneous interruption of registration of the target network slice, the UE 10 makes it possible to confirm that the UE 10 camps on an AoS of an SNPN or VPLMN supporting the target S-NSSAI on the basis of supplemental information regarding the S-NSSAI during the validity period of registration of a network slice of the HPLMN, and to request the SNPN or VPLMN to register the target S-NSSAI.

In addition, the notification regarding network maintenance management may include information regarding a tentatively provided network slice (tentative S-NSSAI) of the HPLMN as a substitute for the network slice (S-NSSAI) whose operation will be stopped, and may further include information regarding the validity period of the tentative S-NSSAI. In addition, in a case where the notification regarding network maintenance management is provided to a UE 10 that has established a PDU session in an RRC_CONNECTED mode by using the S-NSSAI whose operation will be stopped, the notification regarding network maintenance management may include information that explicitly instructs to conduct handover from the S-NSSAI whose operation will be stopped to the tentative S-NSSAI.

Here, even when the tentative S-NSSAI is not included in the Subscribed NSSAI or the Configured NSSAI, the tentative S-NSSAI is treated as a network slice that is available during a designated validity period as a substitute for the S-NSSAI whose operation will be stopped within the HPLMN.

When providing the UE 10 with a notification regarding network maintenance management including information regarding the tentative S-NSSAI, the AMF 301 may notify of an instruction to add the tentative S-NSSAI to the Allowed NSSAI.

As described above, in a case of stopping operation of a specific network slice (S-NSSAI) in a specific Registration Area, a specific Tracking Area (mobility management area), or a specific AoS due to the network maintenance management, it becomes possible to perform maintenance and management for stable operation of the network while reducing impact on users (subscribers, by providing information regarding the VPLMN and/or local network (SNPN) that supports the target network slice in the Registration Area, Tracking Area, or AoS where operation will be stopped.

Note that, each of the above-described processes with regard to the network slice whose operation will be stopped may be diverted to a case of restricting registration of the target network slice with regard to a specific UE10 due to the admission control, or a case of stopping use of the target network slice.

Furthermore, the respective processes according to the above-described embodiments is applicable to all RRC states of the UE 10 (for example, RRC_IDLE, RRC_INACTIVE, or RRC_CONNECTED). For example, in a case where the UE 10 in the RRC_CONNECTED mode with regard to the target S-NSSAI of the HPLMN requests the VPLMN or SNPN to register the target S-NSSAI, a process of conducting the handover to the VPLMN or SNPN is further performed.

Here, the handover to the VPLMN or SNPN is only valid with regard to the target S-NSSAI that has been registered, and a PDU session belonging to the target S-NSSAI of the VPLMN or SNPN is established.

Also, as the supplemental information regarding the Rejected S-NSSAI, the AMF 301 may provide the UE 10 with information regarding one or more corresponding S-NSSAIs of VPLMN or SNPN that makes it possible to conduct the handover with regard to the target S-NSSAI of the HPLMN. In other words, prior to or in conjunction with the handover, the UE 10 requests the VPLMN or SNPN to make registration on the basis of information regarding one or more corresponding S-NSSAIs of the VPLMN or SNPN that makes it possible to conduct the handover, and the UE 10 conducts the handover to one of the S-NSSAIs whose registration is allowed. Here, in a case where the information regarding one or more corresponding S-NSSAIs of the VPLMN or SNPN that makes it possible to conduct the handover includes two or more S-NSSAIs, priorities may be further assigned. The UE 10 selects one S-NSSAI having higher priority on the basis of the priorities.

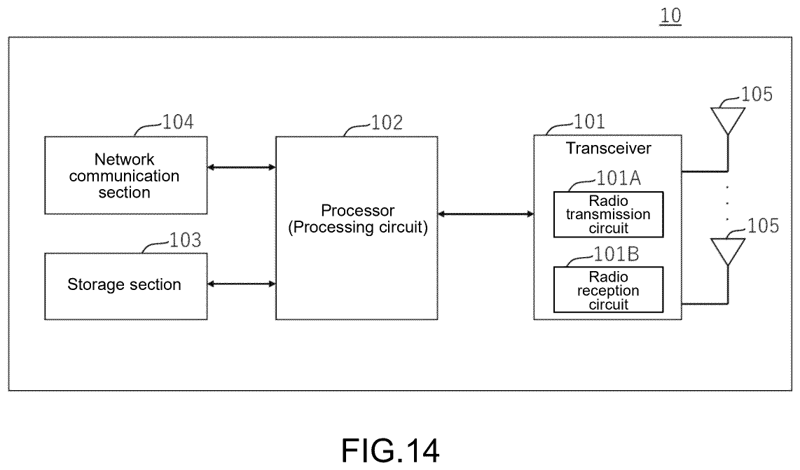

FIG. 14 is a block diagram illustrating an example configuration of the UE 10 that is a terminal device according to the present disclosure. The UE 10 includes a transceiver 101, at least one processor 102, a storage section 103, and a network communication section 104. The transceiver 101 includes a radio transmission circuit 101A and a radio reception circuit 101B. The transceiver 101 is provided with one or more antennas 105. For example, the transceiver 101 transmits and receives radio signals via the antenna 105 between at least one network component including a local 5GC, the 5GC 30, and an access node such as a base station device in the (R)AN 20. The storage section 103 stores instructions to be executed by the processor 102, data or information received from the network component or the like, data or information to be transmitted to the network component or the like, and data or information necessary for processes to be executed by the processor 102. The processor 102 executes an instruction stored in the storage section 103 and executes various processes explained in the above-described embodiments. The processor 102 forms a processing circuit. The network communication section 104 makes it possible to communicate information or data with the network components and the like via the transceiver 101.

The processor 102 may include any combination of hardware for manipulating data or information. The hardware may include, for example, at least one computer, at least one central processing unit (CPU), at least one graphics processing unit (GPU), at least one microprocessor, at least one application specific integrated circuit (ASIC), or at least one field-programmable gate array (FPGA).

The storage section 103 is a hardware storage including, for example, at least one of a random access memory (RAM), a read-only memory (ROM), a hard disk, a compact disc (CD), or a digital video disc (DVD). The storage section 103 may include any other volatile or non-volatile memory that stores information, data, and/or instructions that may be used by the processor 102 of the UE 10.

The UE 10 may include additional components other than the components illustrated in FIG. 14. The UE 10 may include an input device (or input circuit) and an output device (or output circuit). The input device includes a mechanism for inputting data to the UE 10. For example, the input device may include an input mechanism such as a keyboard, a mouse, a touchscreen, a microphone, or the like. The output device may include an output mechanism such as a display, a speaker, or the like.

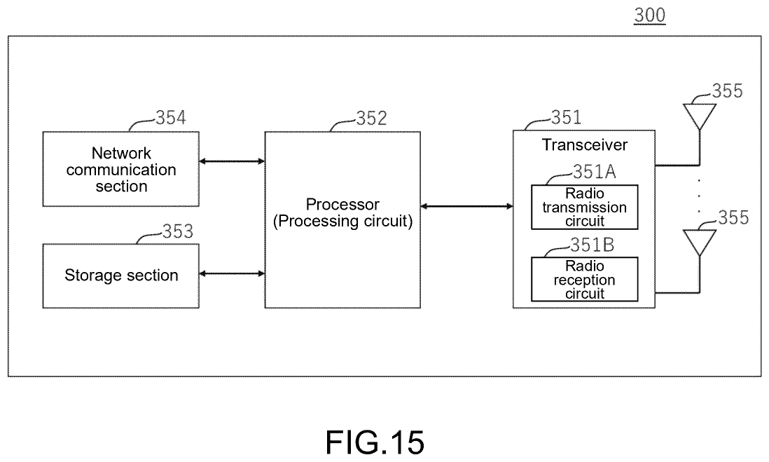

FIG. 15 is a block diagram illustrating an example configuration of a communication device 300 according to the present disclosure. The communication device 300 may include, as an example, any one or more of the components (nodes) 301-312, 330, and 340 in the 5GC 30. For example, the communication device 300 may be one or more NFs including the AMF 312. For example, the communication device 300 may be the AMF 312, a set of the AMF 312 and the NSSF 304, a set of the AMF 312 and the NSACF 312, a set of the AMF 312, the NSSF 304, and the NSACF 312, or any other combination of the NFs.

The communication device 300 may include one or more of a transceiver 351, a processor 352, a storage section 353, and a network communication section 354. The communication device 300 does not have to include the transceiver 351. The transceiver 351 includes a radio transmission circuit 351A and a radio reception circuit 351B. The transceiver 351 is provided with one or more antennas 355. The transceiver 351 transmits and receives a radio signal via the antenna 355 to/from the UE 10 and a network component such as a base station device in the (R)AN 20, other NFs in the 5GC 30, and other 5GCs (visitor 5GC, local 5GC). The storage section 353 stores instructions to be executed by the processor 352, data or information received from the UE 10, the network component, or the like, data or information to be transmitted to the UE 10, the network component, or the like, and data or information necessary for processes to be executed by the processor 352. The processor 352 executes an instruction stored in the storage section 353 and executes various processes explained in the above-described embodiments. The processor 352 forms a processing circuit. The network communication section 354 makes it possible to communicate information or data with the UE 19, the network components, and the like via the transceiver 351.

The processor 352 may include any combination of hardware for manipulating data or information. The hardware may include, for example, at least one computer, at least one central processing unit (CPU), at least one graphics processing unit (GPU), at least one microprocessor, at least one application specific integrated circuit (ASIC), or at least one field-programmable gate array (FPGA).

The storage section 353 is a hardware storage that may include, for example, at least one of a random access memory (RAM), a read-only memory (ROM), a hard disk, a compact disc (CD), or a digital video disc (DVD). The storage section 353 may include any other volatile or non-volatile memory that stores information, data, and/or instructions that may be used by the processor 352 of the communication device 300.

The network communication unit 354 is communicably coupled to the processor 352, receives input information or data to be processed by the processor 352, and transmits information or data output from the processor 352. The network communication section 354 may perform a process such as protocol conversion for communicating with the UE 10 or the above-described network components. The network communication section 354 may include appropriate hardware (for example, a network interface card or the like) and software.

The communication device 300 described with reference to FIG. 15 can also be used as a network component other than the 5GC 30. For example, this communication device may be a 5GC communication device corresponding to a visitor-side public land mobile network including any one or more components (such as NF) in a visitor 5GC. Alternatively, the communication device may be a local-side communication device corresponding to any one or more components (such as NF) in a local 5GC. The visitor-side communication device and the local-side communication device do not have to include the transceiver. Such communication devices may be any one or more base station devices in the (R)AN 20.

According to the present embodiment, with regard to a mobility management area that is a tracking area of a home public land mobile network (HPLMN) that does not support a specific network slice, among visitor public land mobile networks (VPLMNs) included in the EPLMN list or EHPLMN list serving as roaming candidates, the UE 10 is provided with information regarding a visitor public land mobile network that supports the network slice in the tracking area and its service area, that is., Area of Service (AoS). This enables the UE 10 to use a network slice in the service area of the visitor public land mobile network, with regard to at least a portion of a region in the tracking area of the home public land mobile network where network slices is not could not be used in past. In other words, it is possible to improve availability of network slices for the UE 10.

In addition, according to the present embodiment, with regard to a mobility management area of a home public land mobile network that restricts registration of a specific network slice under the admission control, among VPLMNs included in the EPLMN list or EHPLMN list serving as roaming candidates, the UE 10 is provided with information regarding a visitor public land mobile network that supports the network slice in the tracking area and its service area. This enables the UE 10 to use a network slice in the service area of the visitor public land mobile network, with regard to at least a portion of a region in the tracking area of the home public land mobile network where network slices is not could not be used in past.

Furthermore, according to the present embodiment, the core network of the home public land mobile network exposes a request including information regarding an unsupported target network slice and an unsupported mobility management area through the network exposure function (NEF), acquires a response including information regarding a service area that supports the target network slice and information regarding a correspondence relation of the target network slices between the home public land mobile network and the local network from the local network (SNPN), and concludes a dynamic/on-demand service level agreement (SLA) with the SNPN. This makes it possible to treat this local network equally with the above-described visitor public land mobile network. In other words, the availability of the network slices can be further improved.

The present invention is not limited to the above embodiment as it is and can be realized by modifying the components in a range without departing from the spirit thereof in the step of implementation. In addition, various inventions can be formed by optionally combining a plurality of components disclosed in the above embodiment. For example, some components may be omitted from all the components shown in the embodiment. Further, the components may be arbitrarily combined across the different embodiments.

Also, the procedure for the processes described in the present disclosure may be regarded as a method including such a series of procedures. Alternatively the procedure may be regarded as a program for causing a computer to perform such a series of procedures. The procedure for the processes may be executed by causing a computer to load a recording medium that stores the program. In addition, the above-described processes are executed by a processing circuit or a processor such as a CPU of the computer. Also, since the type of the recording medium does not affect the embodiments of the present disclosure, the type is not particularly limited.

Note that each component (NF) illustrated in FIG. 1 according to the present disclosure may be realized by software or may be realized by hardware. For example, each component may be a software module that is realized by software such as a micro program, and each component may be realized by a processor executing the software module. Alternatively each component may be realized by a circuit block on a semiconductor chip (die), for example, an integrated circuit such as an application specific integrated circuit (ASIC) or a field programmable gate array (FPGA). Also, the number of components and the number of pieces of hardware that realizes the components may not be the same. For example, one processor or circuit may realize a plurality of components. Conversely one component may be realized by a plurality of processors or circuits.

Note that the type of the processor described in the present disclosure is not limited. For example, it may be a CPU, a micro processing unit (MPU), a graphics processing unit (GPU), or the like.

Also, the term “X-th” of X-th information (X represents any integer greater than or equal to 1) in the description according to the present disclosure is used to distinguish various types of information, and the X-th information does not have to uniquely identify specific information. For example, the information regarding whether registration of a network slice (first network slice) is allowed in a Registration Area of a terminal device in a home public land mobile network may be described as the first information or may be described as Y-th information (Y represents any integer greater than or equal to 2)

Note that, the present disclosure may also be configured as below.

### Core Network Side Communication Device

(1) A communication device that executes, in a registration process of registering a terminal device or in an update process of updating registration of the terminal device,
   a process of receiving, from the terminal device, a first set of identification information regarding at least one network slice whose registration in a registration area of a home public land mobile network is requested,
   a process of acquiring first information regarding whether the first network slice indicated by the identification information included in the first set is allowed to be registered in the registration area, and
   a process of creating, on the basis of the first information, second information regarding a visitor public land mobile network that enables the first network slice to be provided in an area overlapping with at least the registration area.
(2) The communication device according to (1), in which the first set is Requested NSSAI.
(3) The communication device according to (1) or (2), in which
in a case where the first information does not allow registration of the first network slice in a first mobility management area in the registration area of the home public land mobile network, the communication device executes a process of creating the second information including a first network identifier of the visitor public land mobile network and information for specifying a service region that is a part in the first mobility management area, the visitor public land mobile network enabling the first network slice to be provided in the service region.
(4) The communication device according to any of (1) to (3), in which
in a case where the first information indicates that registration of the first network slice is not allowed in the first mobility management area, the communication device executes a process of creating the second information including a second network identifier of a local network and information for specifying a service region that is a part in the first mobility management area, the local network enabling the first network slice to be provided in the service region.
(5) The communication device according to (4), in which
the communication device executes
   a process of exposing a request including geographical information corresponding to the first mobility management area and information regarding the first network slice,
   a process of acquiring third information in response to the request, the third information including the second network identifier of the local network and the information for specifying the service region, the local network enabling the first network slice to be provided, and
   a process of creating the second information on the basis of the third information, the second information including the second network identifier of the local network and the information for specifying the service region, the local network enabling the first network slice to be provided.
(6) The communication device according to (5), in which
the information regarding the first network slice includes at least the number of QoS flows to be treated by the first network slice, and characteristics of the respective QoS flows.
(7) The communication device according to (6), in which
the characteristics of the QoS flow include at least one of a resource type, priority, a packet delay budget, a packet error rate, an averaging window, or a maximum data burst volume.
(8) The communication device according to (7), in which
the resource type is a GBR QoS flow or a non-GBR QoS flow.
(9) The communication device according to any of (1) to (8), in which
the second information includes information indicating allowance of transmission of a request for registration of the first network slice to the visitor public land mobile network in the service region being a part in the first mobility management area.
(10) The communication device according to any of (3) to (9), in which
the second information includes information indicating allowance of transmission of a request for registration of the first network slice to the local network in the service region being a part in the first mobility management area.
(11) The communication device according to any of (1) to (10), in which
the service region is a second mobility management area belonging to the visitor public land mobile network.
(12) The communication device according to any of (1) to (11), in which
the service region is a region of a first cell belonging to the visitor public land mobile network.
(13) The communication device according to any of (3) to (12), in which
the service region is a region of a second cell belonging to the local network.
(14) The communication device according to any of (3) to (13), in which
the communication device executes
   a process of acquiring fourth information regarding priority of registration of the first network slice included in the first set, and
   a process of determining, on the basis of the fourth information, whether to include, into the second information, the first network identifier of the visitor public land mobile network and the information for specifying the service region being a part in the first mobility management area, the visitor public land mobile network enabling the first network slice to be provided in the service region.
(15) The communication device according to any of (3) to (14), in which
the communication device executes
   a process of acquiring fourth information regarding priority of registration of the network slice included in the first set, and
   a process of determining, on the basis of the fourth information, whether to include, into the second information, a second network identifier of a local network and the information for specifying the service region being a part in the first mobility management area, the local network enabling the first network slice to be provided in the service region.
(16) The communication device according to (1), in which
in a case where the first information indicates that registration of the first network slice is not allowed in a first mobility management area in the registration area of the home public land mobile network, the communication device executes a process of acquiring fifth information regarding a cause not to allow the registration, and
in a case where the fifth information indicates a cause related to the admission control,
   the communication device executes
      a process of setting a backoff period that is a period until reregistration of the first network slice is allowed in the registration area or in the first mobility management area, and
      a process of creating the second information including information regarding the backoff period.
(17) The communication device according to (1), in which
in a case where the first information indicates that registration of the first network slice is allowed in a first mobility management area in the registration area of the home public land mobile network,
   the communication device executes
      a process of receiving sixth information regarding admission control,
      a process of setting a validity period of registration of the first network slice on the basis of the sixth information, and
      a process of adding, to the second information, information regarding the validity period of registration of the first network slice.
(18) The communication device according to (17), in which
the communication device executes
   a process of deciding a condition for reregistration of the first network slice that is applied after the validity period of registration of the first network slice expires, and
   a process of adding, to the second information, seventh information regarding the decided condition for reregistration.
(19) The communication device according to (18), in which
the condition for reregistration is that reregistration is prohibited in the registration area or in the first mobility management area.
(20) The communication device according to (18), in which
the condition for reregistration is that a backoff period until the reregistration is allowed in the registration area or in the first mobility management area expires.
(21) The communication device according to any of (17) to (20), in which
after the validity period of registration of the first network slice expires, the communication device executes a process of deleting the first network slice from a second set of network slices whose registration is allowed.
(22) The communication device according to any of (18) to (21), in which
in a case where the condition for reregistration is that reregistration is prohibited in the registration area or in the first mobility management area, the communication device executes a process of adding the first network slice to a third set of network slices whose registration is rejected.
(23) The communication device according to any of (18) to (22), in which
upon adding the first network slice to the third set, the communication device executes a process of adding, to the second information, a first network identifier of a visitor public land mobile network and information for specifying a service region that is a part in the first mobility management area, the visitor public land mobile network enabling the first network slice to be provided in the service region.
(24) The communication device according to any of (18) to (23), in which
upon adding the first network slice to the third set, the communication device executes a process of adding, to the second information, a second network identifier of a local network and information for specifying a service region that is a part in the first mobility management area, the local network enabling the first network slice to be provided in the service region.
(25) The communication device according to any of (18) to (24), in which
in a case where the condition for reregistration is that a backoff period until reregistration is allowed in the registration area or in the first mobility management area expires, the communication device executes a process of adding the first network slice and information regarding the backoff period to a fourth set of network slices whose registration is pending.
(26) The communication device according to any of (1) to (25), in which
the communication device executes a process of providing the second information to the terminal device.
(27) The communication device according to any of (1) to (26), in which
the first information includes a second set of network slices whose registration is allowed, and
the communication device executes a process of creating, as the second information, a first set of a mobility management area that allows registration of respective network slices included in the second set and a mobility management area that does not allow registration of the respective network slices included in the second set.
(28) The communication device according to (27), in which
the second information includes eighth information indicating whether information regarding the mobility management area included in the first set of the mobility management areas is a mobility management area that allows registration of the respective network slices included in the second set or a mobility management area that does not allow registration of respective network slices included in the second set.
(29) The communication device according to any of (1) to (28), in which
the first information includes a second set of network slices whose registration is allowed, and
the communication device executes
   a process of acquiring ninth information regarding admission control,
   a process of deciding, on the basis of the ninth information, a second condition for reregistration of the first network slice included in the second set in a second mobility management area in the registration area of the home public land mobile network, and
   a process of including, into the second information, the second condition for the registration of the first network slice.
(30) The communication device according to any of (1) to (28), in which
the first information includes a second set of network slices whose registration is allowed, and
the communication device executes
   a process of acquiring tenth information regarding operation and maintenance of the network slice,
   a process of deciding, on the basis of the tenth information, a second condition for registration of the first network slice included in the second set in a second mobility management area in the registration area of the home public land mobile network, and
   a process of including, into the second information, the second condition for the registration of the first network slice.
(31) The communication device according to (29) or (30), in which
the second condition is that a validity period is set for the registration of the first network slice.
(32) The communication device according to (29) or (30), in which
the second condition is that the registration of the first network slice is canceled.
(33) The communication device according to (31) or (32), in which
the communication device executes
   a process of creating the second information including the second condition, and
   a process of transmitting the second information to the terminal device.
(34) The communication device according to any of (1) to (33), in which
the first information includes a second set of network slices whose registration is allowed, and
the communication device executes
   a process of acquiring fourth information regarding priority of registration of a network slice included in the first set,
   a process of acquiring 11th information indicating two or more network slices simultaneously allowed to be registered, and
   a process of selecting the network slice included in the second set on the basis of the first set, the fourth information, and the 11th information.
(35) The communication device according to (34), in which
the network slice included in the second set is selected in such a manner that more network slices having higher priorities on the fourth information are included in comparison with two or more of the network slices included in the 11th information.
(36) The communication device according to (3), in which
in a case where the second information includes two or more first network identifiers of the visitor public land mobile networks each enabling the first network slice to be provided, the communication device executes a process of assigning 12th information regarding priority to each of the first network identifiers.
(37) The communication device according to (36), in which
the 12th information regarding the priority is decided on the basis of the size of the service region of the visitor public land mobile network corresponding to the first network identifier.
(38) The communication device according to (36), in which
the 12th information regarding the priority is decided on the basis of the size of a frequency bandwidth that covers the service region of the visitor public land mobile network corresponding to the first network identifier.
(39) The communication device according to (36), in which
the 12th information regarding the priority is decided on the basis of a validity period set for the service region of the visitor public land mobile network corresponding to the first network identifier.
(40) The communication device according to any of (29) to (33), in which
the communication device executes a process of creating the second information including identification information regarding a second network slice tentatively provided from the home public land mobile network, and 13th information regarding allowance of registration of the second network slice, the 13th information being included as a substitute for the registration of the first network slice.

### Terminal Device

(41) A terminal device that executes
   a process of transmitting a first set of identification information regarding at least one network slice whose registration in a registration area of a home public land mobile network is requested,
   a process of receiving first information regarding whether registration of a first network slice indicated by the identification information included in the first set is allowed in the registration area, and
   a process of receiving second information regarding a visitor public land mobile network that enables the first network slice to be provided in an area overlapping with the registration area, the second information being created on the basis of the first information.
(42) The terminal device according to (41), in which
the first set is Requested NSSAI.
(43) The terminal device according to (41) or (42), in which
in a case where the first information indicates that registration of the first network slice is not allowed in a first mobility management area in the registration area of the home public land mobile network, the terminal device executes a process of receiving the second information including a first network identifier of the visitor public land mobile network and information for specifying a service region that is a part in the first mobility management area, the visitor public land mobile network enabling the first network slice to be provided in the service region.
(44) The terminal device according to any of (41) to (43), in which
in a case where the first information indicates that registration of the first network slice is not allowed in the first mobility management area, the terminal device executes a process of receiving the second information including a second network identifier of a local network and information for specifying a service region that is a part in the first mobility management area, the local network enabling the first network slice to be provided in the service region.
(45) The terminal device according to any of (41) to (44), in which
the second information includes information indicating allowance of transmission of a request for registration of the first network slice to the visitor public land mobile network in the service region being a part in the first mobility management area.
(46) The terminal device according to any of (42) to (45), in which
the second information includes information indicating allowance of transmission of a request for registration of the first network slice to the local network in the service region being a part in the first mobility management area.
(47) The terminal device according to any of (41) to (46), in which
the service region is a second mobility management area belonging to the visitor public land mobile network.
(48) The terminal device according to any of (41) to (47), in which
the service region is a region of a first cell belonging to the visitor public land mobile network.
(49) The terminal device according to any of (44) to (48), in which
the service region is a region of a second cell belonging to the local network.
(50) The terminal device according to any of (43) to (49), in which
the terminal device executes a process of transmitting third information regarding priority of registration of a network slice included in the first set.
(51) The terminal device according to (41), in which
the second information includes fourth information regarding a backoff period that is a period until reregistration of the first network slice is allowed in the registration area or in the first mobility management area, and
the terminal device executes a process of setting, on the basis of the fourth information, a value of a first timer that controls a period up to transmission of reregistration of the first network slice.
(52) The terminal device according to (41) or (42), in which
the second information includes fifth information regarding a validity period of registration of the first network slice, and
the terminal device executes a process of setting, on the basis of the fifth information, a value of a second timer that controls the validity period of registration of the first network slice.
(53) The terminal device according to (52), in which
the terminal device executes
   a process of establishing a session that uses the first network slice,
   a process of stopping the second timer during a period when the session is established, and
   a process of resetting and restarting the second timer when releasing the session.
(54) The terminal device according to (52) or (53), in which
the terminal device executes a process of acquiring sixth information regarding a condition for reregistration of the first network slice that is applied after the validity period of registration of the first network slice expires.
(55) The terminal device according to (54), in which
the condition for reregistration is that reregistration is prohibited in the registration area or in the first mobility management area.
(56) The terminal device according to (54), in which
the condition for reregistration is that a backoff period until the reregistration is allowed in the registration area or in the first mobility management area expires.
(57) The terminal device according to (56), in which
the terminal device executes a process of setting, on the basis of the sixth information, a value of a third timer that controls a period up to transmission of reregistration of the first network slice.
(58)

The terminal device according to any of (52) to (57), in which
after the validity period of registration of the first network slice expires, the terminal device executes a process of deleting the first network slice from a second set of network slices whose registration is allowed.
(59) The terminal device according to any of (55) to (58), in which
in a case where the condition for reregistration is that reregistration is prohibited in the registration area or in the first mobility management area, the terminal device executes a process of adding the first network slice to a third set of network slices whose registration is rejected.
(60) The terminal device according to (51), in which
the terminal device executes a process of adding the first network slice to a fourth set of network slices whose registration is pending.
(61) The terminal device according to any of (43) to (60), in which
the terminal device includes a fifth set of network identifiers of the public land mobile networks being roaming candidates,
the terminal device executes a process of determining whether the fifth set includes the first network identifier included in the second information,
in a case where the fifth set includes the first network identifier,
   the terminal device executes
      a process of first selection or process of first reselection of a cell or synchronization signal block provided by a first base station device belonging to the home public land mobile network and
      a process of second selection or process of second reselection of a cell or synchronization signal block provided by a second base station device belonging to the visitor public land mobile network indicated by the first network identifier, and
in a case where the first base station device related to the cell or synchronization signal block selected through the process of first selection or process of first reselection belongs to the first mobility management area and the second base station device related to the cell or synchronization signal block selected through the process of second selection or process of second reselection belongs to the service region,
   the terminal device transmits a request for registration of the first network slice to the visitor public land mobile network indicated by the first network identifier.
(62) The terminal device according to (61), in which
the terminal device includes a fifth set of network identifiers of the public land mobile networks being roaming candidates,
the terminal device executes a process of receiving an instruction to add the second network identifier to the fifth set,
the terminal device executes a process of determining whether the fifth set includes the second network identifier included in the second information,
in a case where the fifth set includes the second network identifier,
   the terminal device executes a process of third selection or process of third reselection of a cell or synchronization signal block provided by a third base station device belonging to the local network indicated by the second network identifier, and
in a case where the first base station device related to the cell or synchronization signal block selected through the process of first selection or process of first reselection belongs to the first mobility management area and the third base station device related to the cell or synchronization signal block selected through the process of third selection or process of third reselection belongs to the service region,
   the terminal device transmits a request for registration of the first network slice to the local network indicated by the second network identifier.
(63) The terminal device according to (41), in which
the first information includes a second set of network slices whose registration is allowed, and
the second information includes a first set of a mobility management area that allows registration of respective network slices included in the second set and a mobility management area that does not allow registration of the respective network slices included in the second set.
(64) The terminal device according to (63), in which
the second information includes seventh information indicating whether information regarding the mobility management area included in the first set of the mobility management areas is a mobility management area that allows registration of the respective network slices included in the second set or a mobility management area that does not allow registration of the respective network slices included in the second set.
(65) The terminal device according to (43), in which
in a case where the second information includes two or more first network identifiers of the visitor public land mobile networks each enabling the first network slice to be provided, and eighth information regarding priorities respectively assigned to the two or more first network identifiers, the terminal device executes a process of selecting the visitor public land mobile network corresponding to one of the two or more first network identifiers on the basis of the eighth information.
(66) The terminal device according to (41), in which
in a case where the second information includes identification information regarding a second network slice tentatively provided from the home public land mobile network, and ninth information regarding allowance of registration of the second network slice, the ninth information being included as a substitute for the registration of the first network slice,
   the terminal device executes a process of updating a first session established via the first network slice to a second session established through the second network slice.
(67) The terminal device according to (66), in which
the first session is updated to the second session in a handover process.
(68) The terminal device according to (66) or (67), in which
the identification information regarding the second network slice is identification information regarding a network slice that is not included in a fifth set including identification information regarding a subscribed network slice.
(69) The terminal device according to any of (66) to (68), in which
the second information includes tenth information regarding a validity period of the registration of the second network slice, and
the terminal device executes a process of starting a timer for which the validity period is set on the basis of the tenth information.
(70) The terminal device according to (69), in which
the terminal device executes
   a process of adding the identification information regarding the second network slice to a second set of network slices whose registration is allowed, and
   a process of deleting the identification information regarding the second network slice from the second set after the validity period of the timer expires.

### Communication System

(71) A communication system including:
a terminal device that transmits a request for registration of a first network slice, the request for registration including a first set of identification information regarding at least one network slice whose registration in a registration area of a home public land mobile network is requested; and
a communication device that acquires, on the basis of the request for registration, first information regarding whether to allow registration of the first network slice in the registration area, the first network slice being indicated by the identification information, and that creates, on the basis of the first information, second information regarding a visitor public land mobile network that enables the first network slice to be provided in an area overlapping with the registration area, wherein
in a case where the first information indicates that registration of the first network slice is allowed, the communication device includes, into the second information, information necessary to set a period of registration of the first network slice,
in a case where the first information indicates that registration of the first network slice is rejected, the communication device includes, into the second information, information necessary to reregister the first network slice, and
the terminal device receives the first information and the second information from the communication device.

### Local Network Side Device

(72) A communication device that executes
a process of acquiring, from a home public land mobile network, geographical information corresponding to a first mobility management area and information regarding a first network slice,
a process of checking whether a service region of a local network is included in an area indicated by the geographical information, and
a process of setting a third network slice on the basis of the information regarding the first network slice in a case where the service region is included in the area indicated by the geographical information.
(73) The communication device according to (72), in which
the information regarding the first network slice includes at least the number of QoS flows to be assigned to the first network slice, and characteristics of the respective QoS flows.
(74) The communication device according to (73), in which
the characteristics of the QoS flow are a 5G QoS identifier (5QI).
(75) The communication device according to (73), in which
the characteristics of the QoS flow include at least one of a resource type, priority, a packet delay budget, a packet error rate, an averaging window, or a maximum data burst volume.
(76) The communication device according to (75), in which
the resource type is a GBR QoS flow or a non-GBR QoS flow.
(77) The communication device according to any of (73) to (75), in which
the number of QoS flows assigned to the third network slice is set on the basis of the number of QoS flows included in the information regarding the first network slice.
(78) The communication device according to any of (73) to (77), in which
characteristics of the QoS flow assigned to the third network slice are set on the basis of the characteristics of the respective QoS flows included in the information regarding the first network slice.
(79) The communication device according to any of (72) to (78), in which
the communication device executes a process of creating second information regarding mapping of the first network slice and the third network slice.
(80) The communication device according to any of (72) to (79), in which
the communication device executes
   a process of creating third information including the number of QoS flows to be assigned to the third network slice, the characteristics of the respective QoS flows, and the second information, and
   a process of providing the third information to a home public land mobile network.

### Terminal Device in Different Form

(81) A terminal device that executes
a process of transmitting a first set including first identification information regarding at least one network slice whose registration is requested,
a process of acquiring first information regarding admission control for each piece of first identification information included in the first set, and
a process of selecting, on the basis of the first information, a second network slice used to establish a session.
(82) The terminal device according to (81), in which
the terminal device executes
   a process of acquiring second information regarding whether to allow registration of the network slice included in the first set, and
   a process of selecting, from the third network slices whose registration is allowed, the second network slice used to establish the session, the selection being performed on the basis of the first information and the second information.
(83) The terminal device according to (81) or (82), in which
the second information includes a set of second identification information regarding the third network slice, and
the terminal device executes
   a process of acquiring, from the set of the second identification information, assistance information used to select identification information corresponding to the second network slice, the acquisition being performed on the basis of the first information, and
   a process of selecting the identification information corresponding to the second network slice on the basis of the assistance information.
(84) The terminal device according to (83), in which
for each piece of second identification information, the first information includes the number of terminal devices registered, the number of sessions established, and/or the number of the terminal devices each having established at least one session.
(85) The terminal device according to (83), in which
for each piece of second identification information, the first information includes the number of terminal devices registered, the number of the terminal devices each having established at least one session, and/or a notification indicating whether the number of PDU sessions established has reached a maximum value.
(86) The terminal device according to (83), in which
for each piece of second identification information, the first information includes the number of terminal devices registered, the number of the terminal devices each having established at least one session, and/or a notification indicating that the number of sessions established exceeds a threshold.
(87) The terminal device according to (86), in which
the threshold is set by a home public land mobile network.
(88) The terminal device according to (86), in which
the threshold is set by a visitor public land mobile network.

### Registration Area Setting Method

(89) A method of setting a registration area that includes at least one mobility management area including a first mobility management area, the method including:
setting a second mobility management area that is in the first mobility management area or overlaps with the first mobility management area; and
performing control in such a manner that the second mobility management area is taken into consideration for selection or reselection of a cell added through dual connectivity or of a beam, or for selection or reselection of a cell included in a component carrier added through carrier aggregation or of a beam.
(90) The method according to (89), further including
a process of allowing registration of a network slice available only in the second mobility management area.

### Base Station Device

(91) A base station device that executes, in a registration area that includes at least one first mobility management area and at least one second mobility management area,
a process of selecting a setting regarding priority of a measurement frequency band in a process of selecting or reselecting a cell or a beam,
a process of controlling a terminal device on the basis of the setting regarding the priority of the measurement frequency band, in such a manner that measurement for the process of Selecting or reselecting a first cell or a first beam is performed on the first mobility management area, and
a process of controlling the terminal device on the basis of the setting regarding the priority of the measurement frequency band, in such a manner that measurement for the process of selecting or reselecting a second cell added through dual connectivity, or a second beam is performed on the second mobility management area.
(92) The base station device according to (91), in which
the second mobility management area includes a second base station device that provides the second cell operating in a specific frequency band, or the second beam.
(93) The base station device according to (91) or (92), in which
operation frequency bands are classified into two or more ranges, and
the specific frequency band is classified into a range of a higher frequency band from among the two or more ranges of the classified operation frequency bands.

### Reference Signs List

10 UE (User Equipment) or terminal device
20 RAN/AN (Radio Access Network/Access Network)
30 core network
301 AMF (Access and Mobility Management Function)
302 NEF (Network Exposure Function)
303 NRF (Network Repository Function)
304 NSSF (Network Slice Selection Function)
305 PCF (Policy Control Function)
306 SMF (Session Management Function)
307 UDM (Unified Data Management)
308 AF (Application Function)
309 AUSF (Authentication Server Function)
310 UCMF (UE radio Capability Management Function)
311 LMF (Location Management Function)
312 NSACF (Network Slice Access Control Function)
40 application server
101 transceiver
102 processor
103 storage section
104 network communication section
101A radio transmission circuit
101B radio reception circuit
105 antenna
300 communication device
351 transceiver
352 processor
353 storage section
354 network communication section
351A radio transmission circuit
351B radio reception circuit
355 antenna

1-20. (canceled)

21. A communication device, comprising:
circuitry configured to:
transmit information related to Allowed Network Slice Selection Assistance Information (NSSAI) including one or more Single Network Slice Selection Assist Information (S-NSSAIs) to a terminal device during registration processing based on a registration request from the terminal device;
after the registration processing, update the information related to the Allowed NSSAI based on determination of a validity time for at least one S-NSSAI of the one or more S-NSSAIs;
transmit the updated information related to the Allowed NSSAI and the validity time to the terminal device; and
remove the at least one S-NSSAI from the Allowed NSSAI after expiration of the validity time.

22. The communication device according to claim 21, wherein the validity time for the at least one S-NSSAI of the one or more S-NSSAIs is determined based on admission control for the one or more S-NSSAIs.

23. The communication device according to claim 21, wherein the circuitry is further configured to determine the validity time for the at least one S-NSSAI of the one or more S-NSSAIs based on a status of a network slice notified from a Network Slice Admission Control Function (NSACF).

24. The communication device according to claim 23, wherein the status of the network slice includes at least one of
a first number of terminal devices registered for the at least one S-NSSAI,
a number of PDU sessions established based on the at least one S-NSSAI, or
a second number of terminal devices that have established one or more PDU sessions based on the at least one S-NSSAI.

25. The communication device according to claim 23, wherein the circuitry is further configured to subscribe, via a slice event exposure service of the Network Slice Admission Control Function, to notifications of the status of the network slice used to determine the validity time.

26. The communication device according to claim 21, wherein, in a case of removal of the at least one S-NSSAI from the Allowed NSSAI after the expiration of the validity time, the circuitry is further configured to:
provide the terminal device with a backoff timer associated with the removed at least one S-NSSAI; and
prohibit, until expiry of the backoff timer, a re-registration request including the removed at least one S-NSSAI in at least one of
a same registration area,
a same tracking area, or
a same area of service.

27. The communication device according to claim 26, wherein
in a case the re-registration request including the removed at least one S-NSSAI is prohibited in at least one of the same registration area, the same tracking area or the same area of service, the circuitry is further configured to instruct the terminal device to store the removed at least one S-NSSAI as a Rejected S-NSSAI, and
in a case the backoff timer is set, the circuitry is further configured to instruct the terminal device to store the removed at least one S-NSSAI as a Pending S-NSSAI during a backoff period.

28. The communication device according to claim 21, wherein
the circuitry is further configured to obtain the validity time for the at least one S-NSSAI from a Network Slice Selection Function (NSSF), and
the NSSF has acquired network slice validity time information from subscription data for a temporarily available network slice.

29. The communication device according to claim 21, wherein the circuitry is further configured to transmit the updated information related to the Allowed NSSAI and the validity time to the terminal device, based on at least one of a change of the validity time or a change of a status of a network slice.

30. The communication device according to claim 21, wherein the communication device comprises:
an Access and Mobility Management Function (AMF); and
at least one of a Network Slice Selection Function (NSSF) or a Network Slice Admission Control Function (NSACF).

31. A terminal device, comprising:
circuitry configured to:
transmit a request for registration of one or more Single Network Slice Selection Assist Information (S-NSSAIs) to a communication device;
receive information related to Allowed Network Slice Selection Assistance Information (NSSAI) including the one or more S-NSSAIs from the communication device during registration processing;
after the registration processing, receive updated information related to the Allowed NSSAI and a validity time for at least one S-NSSAI of the one or more S-NSSAIs; and
remove the at least one S-NSSAI from the Allowed NSSAI after expiration of the validity time.

32. The terminal device according to claim 31, wherein the validity time for the at least one S-NSSAI of the one or more S-NSSAIs is determined based on admission control for the one or more S-NSSAIs.

33. The terminal device according to claim 31, wherein the circuitry is further configured to receive admission control information for the at least one S-NSSAI of the one or more S-NSSAIs.

34. The terminal device according to claim 33, wherein the circuitry is further configured to select an S-NSSAI to establish a PDU session from among the one or more S-NSSAIs included in the Allowed NSSAI based on the admission control information.

35. The terminal device according to claim 31, wherein in a case validity time information includes a backoff timer associated with the at least one S-NSSAI, the circuitry is further configured to
start the backoff timer and to prohibit, until expiry of the backoff timer, transmission of a request for re-registration including the removed at least one S-NSSAI in at least one of
a same registration area,
a same tracking area, or
a same area of service.

36. The terminal device according to claim 35, wherein
in a case the request for the re-registration including the removed at least one S-NSSAI is prohibited in the same registration area, the same tracking area or the same area of service, the circuitry is further configured to store the removed at least one S-NSSAI as a Rejected S-NSSAI, and
in a case the backoff timer is set, the circuitry is further configured to store the removed at least one S-NSSAI as a Pending S-NSSAI during a backoff period.

37. The terminal device according to claim 31, wherein the circuitry is further configured to:
store, in association with the removed at least one S-NSSAI, information indicating at least one of a registration area, a tracking area, or an area of service in which the removed at least one S-NSSAI is not available; and
to determine whether to transmit a request for re-registration including the removed at least one S-NSSAI based on the stored information.

38. The terminal device according to claim 31, wherein validity time information indicates that the at least one S-NSSAI is a temporarily available network slice configured in subscription data of the terminal device.

39. The terminal device according to claim 31, wherein the circuitry is further configured to receive the updated information related to the Allowed NSSAI in response to at least one of
a change of the validity time, or
a change of a status of a network slice.

40. The terminal device according to claim 31, wherein
in a case the updated information related to the Allowed NSSAI is received, the circuitry is further configured to update a locally stored Allowed NSSAI with the updated information and to start or restart a timer for each S-NSSAI for which the validity time is included in the updated information.
